(19) United States
(12) Patent Application Publication
(10) Pub. No.: US 2003/0170024 A1
(43) Pub. Date: Sep. 11, 2003

(54) Deformable mirror and optical device using the same

(76) Inventors: Kimihiko Nishioka, Tokyo (JP); Shinji Kaneko, Tokyo (JP)

Correspondence Address: PILLSBURY WINTHROP, LLP, P.O. BOX 10500, MCLEAN, VA, 22102, US

(21) Appl. No.: 10/232,817

(22) Filed: Sep. 3, 2002

(30) Foreign Application Priority Data
Sep. 5, 2001 (JP) 2001-268941

(51) Int. Cl. H04J 14/00

(52) U.S. Cl. 398/43

(57) ABSTRACT

A deformable mirror device is configured so that a deformable mirror of the type driven by electrostatic force is housed in a sealed package made of ceramic or plastic. The package is provided with a transparent window on the entrance and exit side of light. Light is incident on a reflecting surface of the deformable mirror through the window, and the light reflected at the reflecting surface emerges through the window.

### BACKGROUND OF THE INVENTION

a) Field of the Invention

The present invention relates to a variable optical-property optical element constructed of a deformable mirror, and an optical device provided with an optical system that includes the same variable optical-property optical element, such as spectacles, a video projector, a digital camera, a TV camera, an endoscope, a telescope, a viewfinder of a camera, and an optical data processor.

b) Description of Related Art

In the conventional optical lens, lenses fabricated out of ground glass are employed. Since focal length of such a lens itself cannot be changed, lens units are moved in a direction of the optical axis for focusing, zooming or magnification change of a camera, for example. As a result, mechanical structure is rendered complicated.

Also, since a motor or the like is used for moving a part of the lens units, there are drawbacks such as large power consumption, noisy sound, long response time, and long time-taking lens movement.

Also, in the case where anti-shake operation is performed, since lenses are mechanically moved by a motor, solenoid or the like, there are drawbacks such as high power consumption and complicated mechanical structure, to raise the cost.

To solve these problems, consideration has been made for variable optical-property optical elements, which, however, has a drawback of easily being scratched.

### SUMMARY OF THE INVENTION

Therefore, the main object of the present invention is to provide a variable optical-property optical element that consumes a small power, is silent, has a short response time, has a simple mechanical structure, hardly is scratched, and contributes to cost reduction.

Another object of the present invention is to provide an optical device provided with the same variable optical-property optical element.

In order to attain these objects, the variable optical-property optical element according to the present invention is formed of a deformable mirror and is housed in a sealed insulator package having a transparent window member.

Also, a deformable mirror according to the present invention is provided with electrodes that are fabricated by printed-wiring technique.

Also, the optical device according to the present invention is configured to perform focusing or magnification change by using a deformable mirror that allows light to be incident thereon from both sides of the mirror surface.

These and other objects as well as features and advantages of the present invention will become apparent from the following detailed description of the preferred embodiments when taken in conjunction with the accompanying drawings.

### BRIEF DESCRIPTION OF THE DRAWINGS

FIG. 1 is a schematic configuration diagram that shows a digital camera's Keplerian viewfinder that uses a deformable mirror according to the present invention.

FIG. 2 is a schematic configuration diagram that shows one embodiment of the deformable mirror according to the present invention.

FIG. 3 is an explanatory diagram that shows one mode of electrodes used in the deformable mirror shown in FIG. 2.

FIG. 4 is an explanatory diagram that shows another mode of electrodes used in the deformable mirror shown in FIG. 2.

FIG. 5 is a schematic configuration diagram that shows another embodiment of the deformable mirror according to the present invention.

FIG. 6 is a schematic configuration diagram that shows still another embodiment of the deformable mirror according to the present invention.

FIG. 7 is a schematic configuration diagram that shows still another embodiment of the deformable mirror according to the present invention.

FIG. 8 is an explanatory diagram that shows the coil density condition of a thin-film coil according to the embodiment shown in FIG. 7.

FIG. 9 is a schematic configuration diagram that shows still another embodiment of the deformable mirror according to the present invention.

FIG. 10 is an explanatory diagram that shows one arrangement example of the coils according to the embodiment shown in FIG. 9.

FIG. 11 is an explanatory diagram that shows another arrangement example of the coils according to the embodiment shown in FIG. 9.

FIG. 12 is an explanatory diagram that shows an arrangement of permanent magnets that is suitable to the case where the embodiment shown in FIG. 7 is modified to arrange the coils 427 as shown FIG. 11.

FIG. 13 is a schematic configuration diagram of an imaging system using a deformable mirror according to the present invention, such as those applied to a digital camera of a cellular phone, a capsule endoscope, an electronic endoscope, a digital camera for a personal computer, and a digital camera for a PDA.

FIG. 14 is a schematic configuration diagram that shows still another embodiment of the deformable mirror according to the present invention.

FIG. 15 is a schematic configuration diagram that shows still another embodiment of the deformable mirror according to the present invention.

FIG. 16 is a diagram that shows the fundamental structure of a variable focus lens, as the variable optical-property optical element according to the present invention.

FIG. 17 is a view that presents a refractive-index ellipsoid of revolution of a uniaxial, nematic liquid crystal molecule.

FIG. 18 is a diagram that shows a condition where electric field is applied to a macromolecular dispersed liquid crystal layer shown in FIG. 16.

FIG. 19 is a diagram that shows one configuration example where the voltage applied to the macromolecular dispersed liquid crystal layer shown in FIG. 16 is variable.

FIG. 20 is a diagram that shows one example of the imaging optical system of a digital camera using the variable focus lens shown in FIG. 19.

FIG. 21 is a diagram that shows one configuration example of a variable-focus, diffraction optical element, as the variable optical-property optical element according to the present invention.

FIG. 22 is a diagram that shows a configuration of variable focus spectacles having variable focus lenses using twisted nematic liquid crystal.

FIG. 23 is a diagram that shows the orientation condition of liquid crystal molecules when the voltage applied to the twisted nematic liquid crystal layer shown in FIG. 22 is set high.

FIG. 24A is a diagram that shows one configuration example of a variable deflection-angle prism to which the principle of the variable focus lens is applied.

FIG. 24B is a diagram that shows another configuration example of the variable deflection-angle prism to which the principle of the variable focus lens is applied.

FIG. 25 is a diagram for explaining modes for use of the variable deflection-angle prism shown in FIG. 24A.

FIG. 26 is a diagram that shows one configuration example of a variable focus mirror applicable to the deformable mirror according to the present invention.

FIG. 27 is a schematic configuration diagram that shows still another embodiment of the deformable mirror according to the present invention.

FIG. 28 is a perspective view that shows still another embodiment of the deformable mirror according to the present invention.

FIG. 29 is a schematic configuration diagram that shows a modification example of the deformable mirror shown in FIG. 28.

FIG. 30 is a perspective view that shows still another embodiment of the deformable mirror according to the present invention.

FIG. 31 is a schematic configuration diagram that shows still another embodiment of the variable mirror according to the present invention.

FIG. 32 is a schematic configuration diagram of a cellular phone with electronic imaging function incorporating therein an optical device that uses the deformable mirror shown in FIG. 28. FIG. 33 is a schematic configuration diagram that shows an example where a transparent window member is arranged to be tilted in reference to the mirror surface in the deformable mirror shown in FIGS. 28-32.

FIG. 34 is a schematic configuration diagram that shows still another embodiment of the deformable mirror according to the present invention.

FIG. 35 is a sectional view that shows still another embodiment of the deformable mirror according to the present invention.

FIG. 36A is an explanatory diagram that shows an example of one-side wiring of the lower substrate, which is fabricated by printed-wiring technique, in the deformable mirror shown in FIG. 35.

FIG. 36B is an explanatory diagram that shows an example of both-side wiring of the lower substrate, which is fabricated by printed-wiring technique, in the deformable mirror shown in FIG. 35.

FIG. 37 is a sectional view that shows still another embodiment of the deformable mirror according to the present invention.

FIG. 38 is a sectional view that shows still another embodiment of an optical system using the deformable mirror according to the present invention.

FIG. 39 is a schematic configuration diagram that shows still another embodiment of the deformable mirror according to the present invention.

FIG. 40 is a schematic configuration diagram that shows a conventional example of the optical system for optical data processing.

FIG. 41 is a schematic configuration diagram that shows one example of the optical system for optical data processing in which a surface illuminant laser and an optical fiber are optically connected with each other via a free curved surface prism.

FIG. 42 is an explanatory diagram of the free curved surface prism in the optical system shown in FIG. 41.

FIG. 43 is a schematic configuration diagram that shows one example of the optical system for optical data processing in which a surface illuminant laser and an optical fiber are optically connected with each other via a reflecting mirror.

FIG. 44 is a schematic configuration diagram that shows another example of the optical system for optical data processing in which a surface illuminant laser and an optical fiber are connected with each other via a free curved surface prism.

FIG. 45 is a schematic configuration diagram of an optical wavelength demultiplexer system that suggests another example of the optical system for optical data processing using a free curved surface prism.

### DETAILED DESCRIPTION OF THE PREFERRED EMBODIMENTS

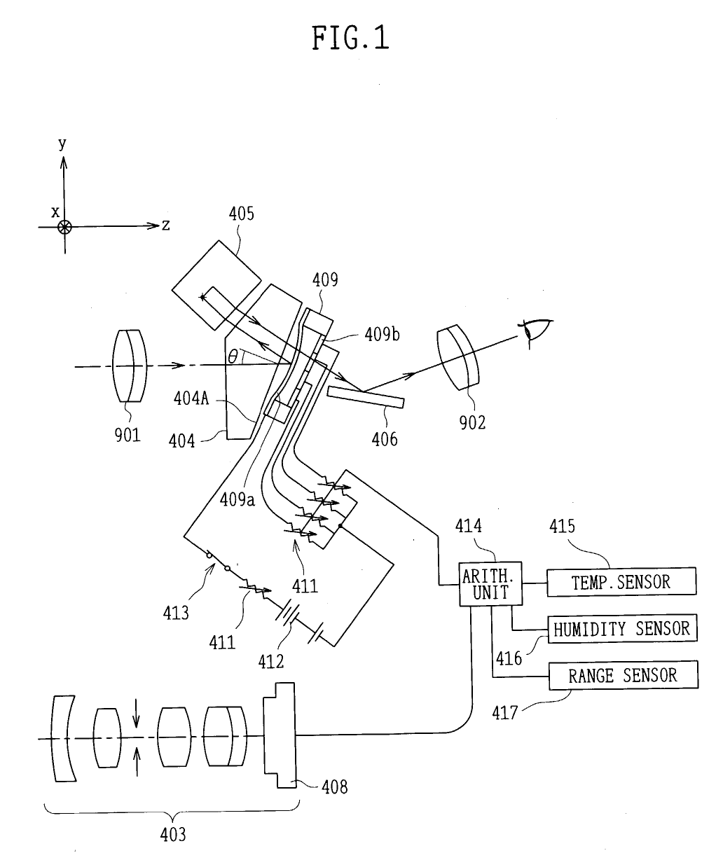

FIG. 1 shows a schematic configuration of a Keplerian viewfinder for a digital camera using a deformable mirror according to the present invention. This configuration may be applied to a silver-halide camera also, as a matter of course.

The deformable mirror 409 shown in FIG. 1 is a variable optical-property optical element including a thin film (reflecting surface) 409a coated with aluminum and a plurality of electrodes 409b. The reference numeral 411 denotes a plurality of variable resistors connected with the electrodes 409b, respectively. The reference numeral 412 denotes a power supply connected, as interposed between, with the thin film 409a and the electrodes 409b through the variable resistors 411 and a power switch 413. The reference numeral 414 denotes an arithmetical unit for controlling resistance values of the plurality of variable resistors 411. The reference numerals 415, 416, and 417 denote a temperature sensor, a humidity sensor, and a range sensor, respectively, connected with the arithmetical unit 414. These members and elements are arranged as shown in the figure, to constitute an optical device.

It is noted that each of surfaces of a prism 404, a rectangular isosceles prism 405, a mirror 406 and the thin film 409a, or each of surfaces excluding those of an objective lens 901 and an eyepiece 902 may be configured as any surface such as a spherical or rotationally symmetric aspherical surface, a spherical, planar or rotationally symmetric aspherical surface that is decentered from the optical axis, an aspherical surface that defines planes of symmetry, only one plane of symmetry or no plane of symmetry, a free curved surface, or a surface having a nondifferentiable point or line. In addition, irrespective of whether it is a reflecting surface or a refracting surface, any surface is applicable as long as it can exert some effect on light. Hereafter, such a surface is generally referred to as an expanded curved surface.

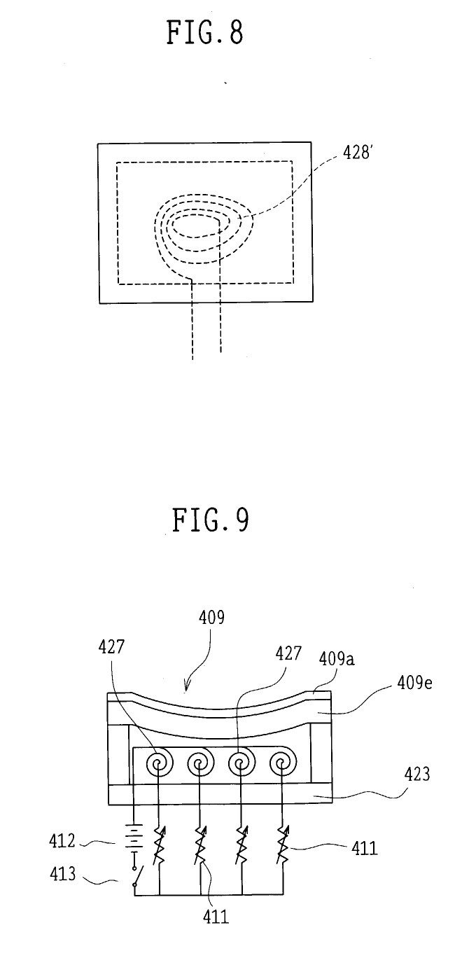

Also, it is designed so that, when a voltage is applied between the plurality of electrodes 409b, the thin film 409a is deformed by electrostatic force to change its surface shape, as in the case of the membrane mirror referred to, for example, in “Handbook of Microlithography, Micromachining and Microfabriation”, edited by P. Rai-Choudhury, Vol.2: Micromachining and Microfabriation, p. 495, FIG. 8.58, SPIE PRESS or “Optics Communication”, Vol.140, pp. 187-190, 1997. Whereby, not only can focus adjustment be made in conformance with diopter of an observer, but also it is possible to suppress degradation of image forming performance, which results from deformation or change of refractive indices of the lenses 901 and 902 and/or the prism 404, the rectangular isosceles prism 405 and the mirror 406 caused by temperature change or humidity change, from expansion/contraction and deformation of lens frames, or from assembling errors of parts such as optical elements and frames. In this way, focus adjustment and compensation for aberrations caused by the focus adjustment can always be performed appropriately.

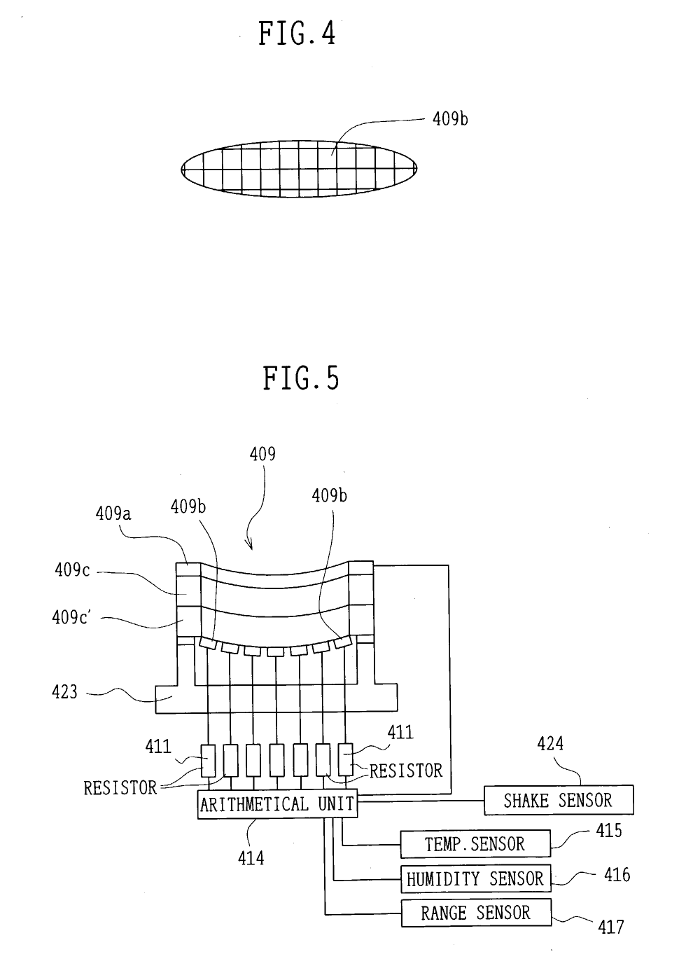

Also, shape of the electrodes 409b may be selected in accordance with deformation pattern of the thin film 409a as shown in FIGS. 3 and 4. Also, fabricating the deformable mirror using lithography technique is easy and thus is preferable.

According to this embodiment, light from the object is refracted at each of entrance surfaces and exit surfaces of the objective lens 901 and the prism 404, is reflected at the deformable mirror 409, is transmitted through the prism 404, is further reflected at the rectangular isosceles prism 405 (in FIG. 1, the mark “+” on the path of rays indicates that rays travel toward the rear side of the figure), is reflected at the mirror 406, and enters the observer's eye via the eyepiece 901. In this way, the lenses 901 and 902, the prisms 404 and 405, and the deformable mirror 409 constitute an observation optical system. Optimizing the surface shape and thickness of each of these optical elements can minimize aberrations on the object surface.

In other words, the shape of the thin film 4O9a, asa reflecting surface, is controlled in such a manner that resistance values of the variable resistors 411 are changed by signals from the arithmetical unit 414, to optimize image forming performance. Signals that have intensities according to ambient temperature, humidity and distance to the object are input into the arithmetical unit 414 from the temperature sensor 415, the humidity sensor 416, and the range sensor 417. In order to compensate for degradation of image forming performance caused by the ambient temperature and humidity and the distance to the object, the arithmetical unit 414 outputs signals for determining resistance values of the variable resistors 411 upon taking into account these input signals, so that voltages which determine the shape of the thin film 409a are applied to the electrodes 409b. In this way, since the thin film 409a is deformed by voltages applied to the electrodes 409b, or electrostatic force, it can assume various shapes including aspherical surfaces in accordance with conditions. If the polarity of the applied voltage is changed, a convex surface also can be formed. It is noted that the range sensor 417 is dispensable. In this case, it is only necessary to move the imaging lens 403 of the digital camera to the position where high-frequency components of an image signal from a solid-state image sensor 408 are substantially maximized, to calculate the object distance on the basis of this position, and to deform the deformable mirror 409 so that an observer's eye is focused on the object image.

Also, if the thin film 409a is made of synthetic resin such as polyimide, it is favorable in that the thin film could be considerably deformed even at a low voltage. Also, the prism 404 and the deformable mirror 409 can be integrally formed into a unit.

Although not shown in the figure, the solid-state image sensor 408 may be integrally formed on the substrate of the deformable mirror 409 by a lithography process.

Also, if the lenses 901 and 902, the prisms 404 and 405, and the mirror 406 are formed with plastic molds, curved surfaces with any desirable shapes can be easily formed and the fabrication process also is simple. In this imaging system, the lenses 901 and 902 are separately provided other than theprism 404. However, if the prisms 404 and 405, the mirror 406, and the deformable mirror 409 can be designed to eliminate aberrations without the lenses 902 and 901, the prisms 404 and 405 and the deformable mirror 409 will form one optical block, to facilitate assembling. A part or all of the lenses 901 and 902, the prisms 404 and 405, and the mirror 406 may be made of glass. Such a configuration would assure an imaging system having a better accuracy.

In the example of FIG. 1, the arithmetical unit 404, the temperature sensor 415, the humidity sensor 416, and the range sensor 417 are provided so that temperature change, humidity change, and change of the object distance are compensated for by the deformable mirror 409. However, the arithmetical unit 414, the temperature sensor 415, the humidity sensor 416 and the range sensor 417 may be removed from the configuration so that the deformable mirror 409 compensates for change of the observer's diopter alone.

Also, while the thin film 409a acts as an electrode also in the deformable mirror 409 of FIG. 1, this electrode maybe provided separately. That is, the configuration may be made so that another conductive thin film is provided to be integrated with the thin film 409a on the side of the electrodes 409b in reference to the thin film 409a, and that a voltage is applied to the conductive thin film via the power switch 413.

Configuring the reflecting film and the electrode separately in this way is preferred because a choice of fabrication method is widened.

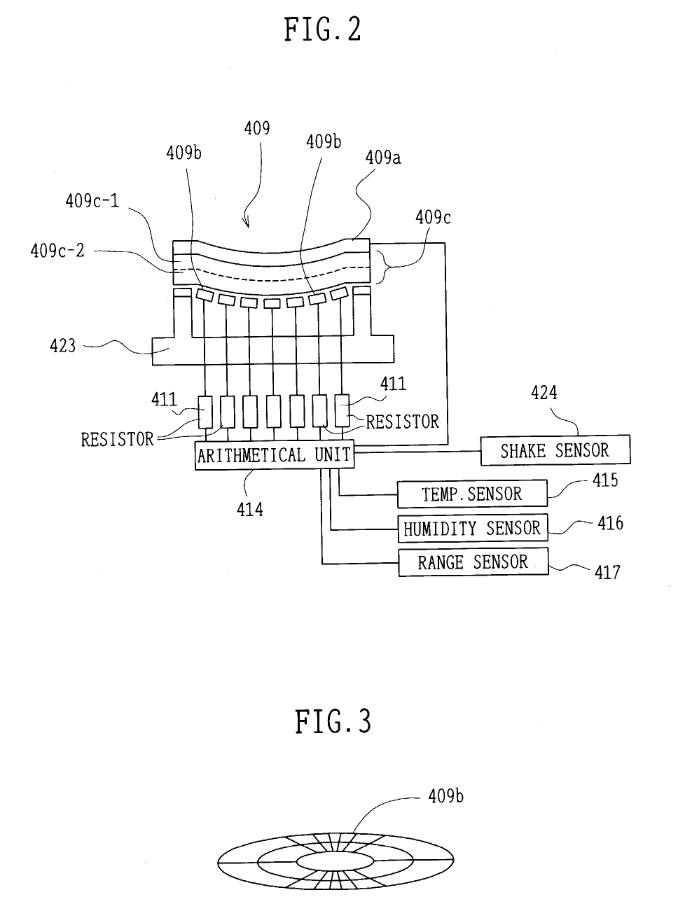

FIG. 2 shows another embodiment of the deformable mirror 409 according to the present invention.

In the deformable mirror 409 of this embodiment, a piezoelectric element 409c is interposed between the thin film 409a and the electrodes 409b, and these elements are mounted on a support 423. By changing voltages applied to the piezoelectric element 409c for individual electrodes 409b to cause different expansion or contraction in the piezoelectric element 409c portion by portion, the configuration allows the shape of the thin film 409a to be changed.

Arrangement of the electrodes 409b may be chosen from a concentric division pattern as illustrated in FIG. 3, a rectangular division pattern as illustrated in FIG. 4, and any other appropriate pattern. In FIG. 2, the reference numeral 424 denotes a shake sensor connected with the arithmetical unit 414. The shake sensor detects shake of a digital camera, for example, and changes voltages applied to the electrodes 409b via the arithmetical unit 414 and the variable resistors 411 so as to deform the thin film 409a for compensation for disturbance of the image by the shake. In this situation, focusing and compensation for temperature and humidity are performed upon signals from the temperature sensor 415, the humidity sensor 416, and the range sensor 417 also being taken into account simultaneously. In this case, since a stress that derives from the deformation of the piezoelectric element 409c is applied to the thin film 409a, it is good practice to give the thin film 409a a considerable thickness to have an appropriate strength.

FIG. 5 shows still another embodiment of the deformable mirror 409 according to the present invention.

The deformable mirror of this embodiment differs from the deformable mirror shown in FIG. 2 in that the piezoelectric element interposed between the thin film 409a and the electrodes 409b is composed of two piezoelectric elements 409c and 409c′ made of substances having piezoelectric characteristics of opposite directionalities. Specifically, if the piezoelectric elements 409c and 409c′ are made of ferroelectric crystals, they are arranged so that the crystal axes thereof are directed opposite to each other. In this case, when voltages are applied, since the piezoelectric elements 409c and 409c′ expand or contract in opposite directions, the force to deform the thin film 409a becomes stronger than in the embodiment of FIG. 2, to result in an advantage that the mirror surface can be considerably deformed.

Substances usable to construct the piezoelectric elements 409c and 409c′ are, for example, piezoelectric substances or polycrystals or crystals thereof such as barium titanate, Rochelle salt, quartz crystal, tourmaline, KDP, ADP and lithium niobite, piezoelectric ceramics such as solid solution of PbZrO₃ and PbTiO₃, organic piezoelectric substances such as PVDF, and other ferroelectrics. In particular, the organic piezoelectric substance is preferable because it has a small value of Young's modulus and brings about a considerable deformation at a low voltage. In application of these piezoelectric elements, if they are made to have uneven thickness, it also is possible to properly deform the thin film 409a in the embodiment.

Also, as substances of the piezoelectric elements 409c and 409c′, macromolecular piezoelectric such as polyurethane, silicon rubber, acrylic elastomer, PZT, PLZT, and PVDF, vinylidene cyanide copolymer, copolymer of vinylidene fluoride and trifluoroethylene, etc. are usable.

Use of the organic substance having a piezoelectric property, the synthetic resin having a piezoelectric property, or the elastomer having a piezoelectric property is favorable because a considerable deformation of the surface of the deformable mirror can be achieved.

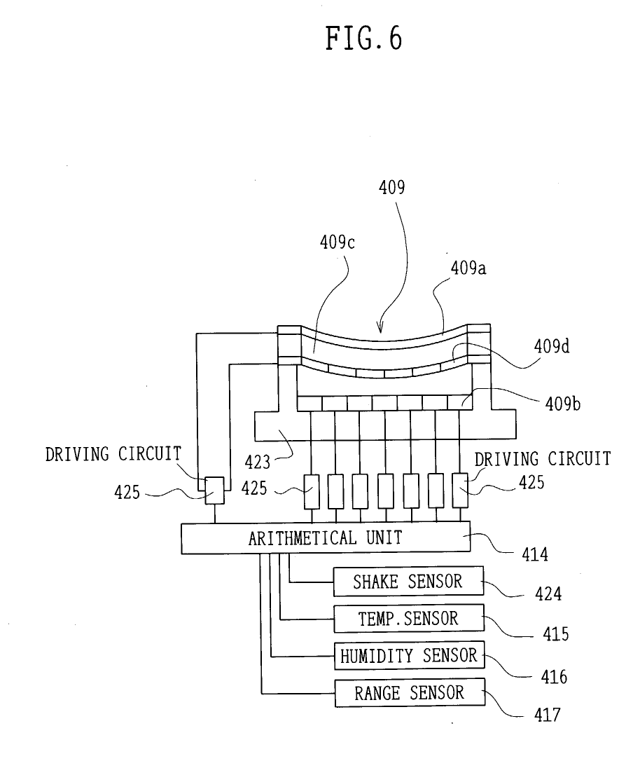

In the case where an electrostrictive substance such as acrylic elastomer or silicon rubber is used for the piezoelectric element 409c shown in FIGS. 2 and 6, the piezoelectric element 409c may have the structure in which another substrate 409c-1 and the electrostrictive substance 409c-2 are cemented together.

FIG. 6 shows another embodiment of the deformable mirror 409 according to the present invention.

The deformable mirror according to this embodiment is designed so that the piezoelectric element 409c is sandwiched between the thin film 409a and an electrode 409d, and a voltage is applied between the thin film 409a and the electrode 409d via a driving circuit 425 which is controlled by the arithmetical unit 414. Furthermore, voltages are applied to the electrodes 409b also, which are mounted on the support 423, via driving circuits 425 controlled by the arithmetical unit 414. Resultantly, according to this embodiment, the thin film 409a can be deformed both by the voltage applied between the thin film 409a and the electrode 409d and by electrostatic force derived from the voltages applied to the electrodes 409b. Therefore, this embodiment has a merit that a larger number of deformation patterns are possible and a faster response is achieved than in the case of any embodiment previously set forth.

Also, the mirror surface can be deformed into either a convex surface or a concave surface upon the sign of the voltage applied between the thin film 409a and the electrode 409d being changed. In this case, it maybe designed so that piezoelectric effect causes a considerable amount of deformation while electrostatic force causes a fine shape change. Alternatively, it may be designed so that piezoelectric effect is mainly used for deformation of a convex surface while electrostatic force is mainly used for deformation of a concave surface. It is noted that the electrode 409d may be constructed of a plurality of electrodes like the electrodes 409b. This configuration is shown in FIG. 6. In this specification, piezoelectric effect, electrostrictive effect, and electrostriction are generally referred to as “piezoelectric effect”. Thus, electrostrictive substance also is classified into piezoelectric substance.

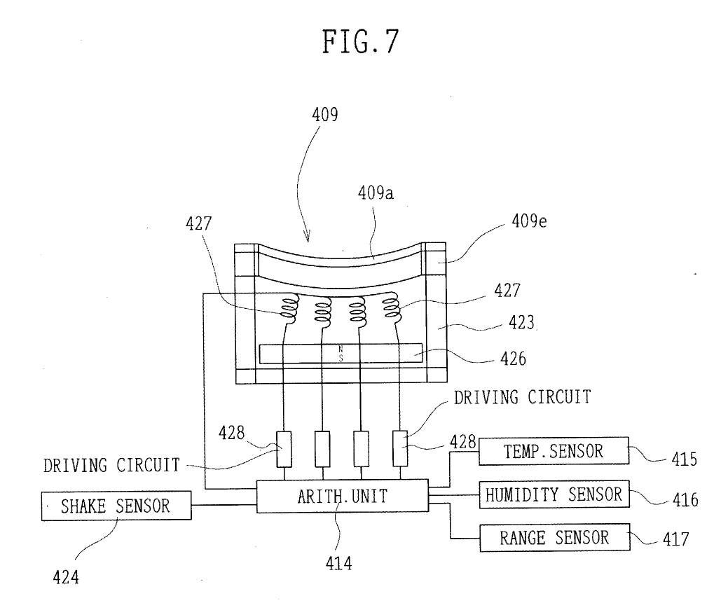

FIG. 7 shows still another embodiment of the deformable mirror 409 according to the present invention.

This embodiment is designed to change the shape of the mirror surface utilizing electromagnetic force. A permanent magnet 426 is mounted and fixed on the inside bottom surface of the support 423 and the peripheral portion of the substrate 409e made of silicon nitride, polyimide or the like is mounted and fixed on the top face of the support 423. The surface of the substrate 409e is provided with the thin film 409a made of metal coating such as aluminum. A plurality of coils 427 are arranged under the substrate 409e, and are connected with the arithmetical unit 414 via the driving circuits 428, respectively. Accordingly, when appropriate currents are supplied to the individual coils 427 from the individual driving circuits 428 based on output signals from the arithmetical unit 414, which depend on a required change of the optical system determined by the arithmetical unit on the basis of signals from the respective sensors 415, 416, 417, and 424, the coils 427 are repelled or attracted by the electromagnetic force acting with the permanent magnet 426, to deform the substrate 409e and the thin film 409a.

In this case, it can be designed so that different amounts of electric current flow through the respective coils 427. Also, the coils 427 may be provided as a single coil or may be arranged on the inside bottom surface of the support 423 upon the permanent magnet 426 being provided on the substrate 409e. Also, fabricating the coils 427 by lithography technique is preferable. In addition, a ferromagnetic iron core may be encased in each coil 427.

In this case, as illustrated in FIG. 8, it can be designed so that coil density of the thin-film coils 427 varies position by position thereby to give the substrate 409e and the thin film 409a a desirable deformation. Also, the coils 427 may be provided as a single coil, or may encase ferromagnetic iron cores inserted therein.

FIG. 9 shows still another embodiment of the deformable mirror 409 according to the present invention.

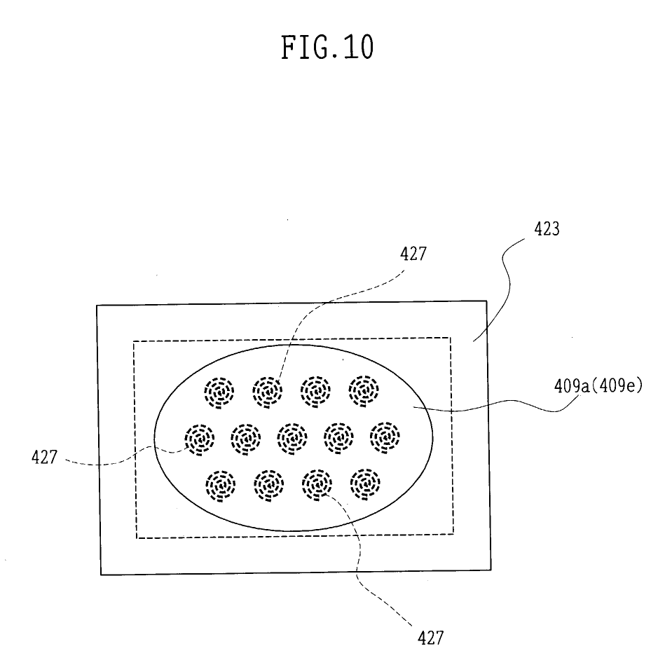

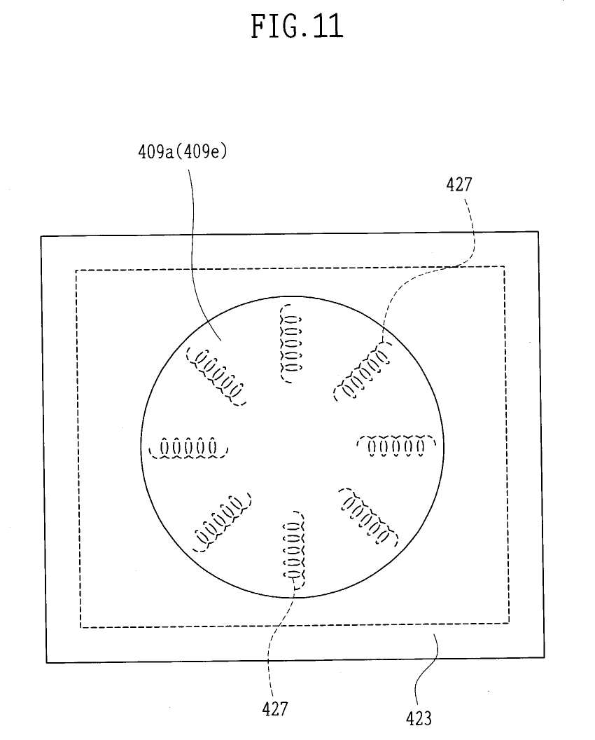

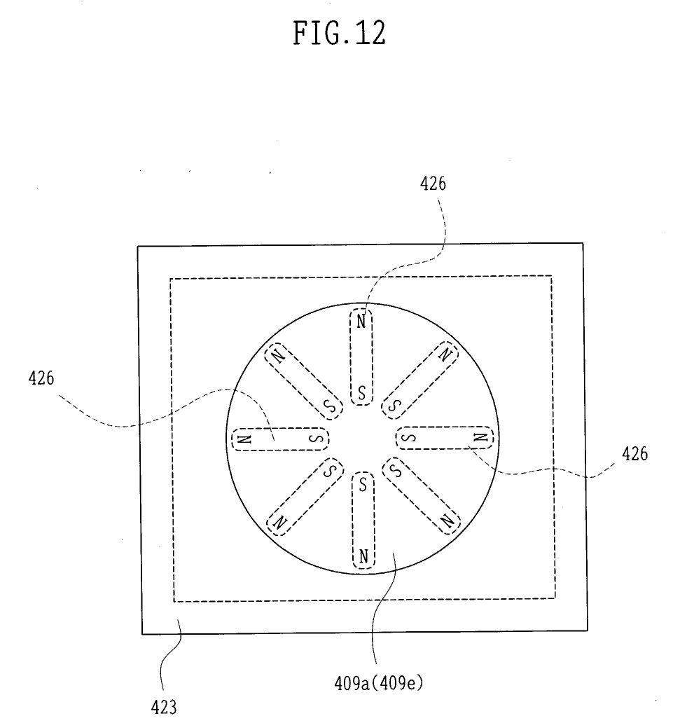

According to this embodiment, the substrate 409e is made of a ferromagnetic such as iron and the thin film 409a as a reflecting film is made of aluminum or the like. In this case, since a thin-film coil is dispensable, the structure can be made simple, to reduce manufacture cost. Also, if the power switch 413 is replaced by an alternation and power on-off switch, directions of currents flowing through the coils 427 are changeable, and accordingly the substrate 409e and the thin film 409a are freely deformable. FIG. 10 shows the arrangement of the coils 427 according to this embodiment. FIG. 11 shows another arrangement example of the coils 427. These arrangements are applicable to the embodiment shown in FIG. 7, also. It is noted that FIG. 12 shows an arrangement of permanent magnets 426 that is suitable to the case where the embodiment shown in FIG. 7 is modified to arrange the coils 427 as shown in FIG. 11. Specifically, the radial arrangement of the permanent magnets 426 as shown in FIG. 12 can give the substrate 409e and the thin film 409a finer deformation than the embodiment shown in FIG. 7. In addition, deforming the substrate 409e and the thin film 409a by electromagnetic force (the embodiments of FIG. 7 and FIG. 9) has a merit that the substrate and the thin film can be driven at a lower voltage than in the case where electrostatic force is used.

While several embodiments of the deformable mirror according to the present invention are described above, two or more kinds of forces may be used for deformation of the mirror as set forth in the embodiment of FIG. 6. Specifically, two or more kinds of forces out of electrostatic force, electromagnetic force, piezoelectric effect, magnetrostriction, pressure of fluid, electric field, magnetic field, temperature change, electromagnetic wave, etc. may be simultaneously used, to deform the mirror. Accordingly, if two or more different driving methods are to be used for deformation of the mirror surface, substantial deformation and fine deformation can be simultaneously achieved, to realize a mirror surface with high accuracy.

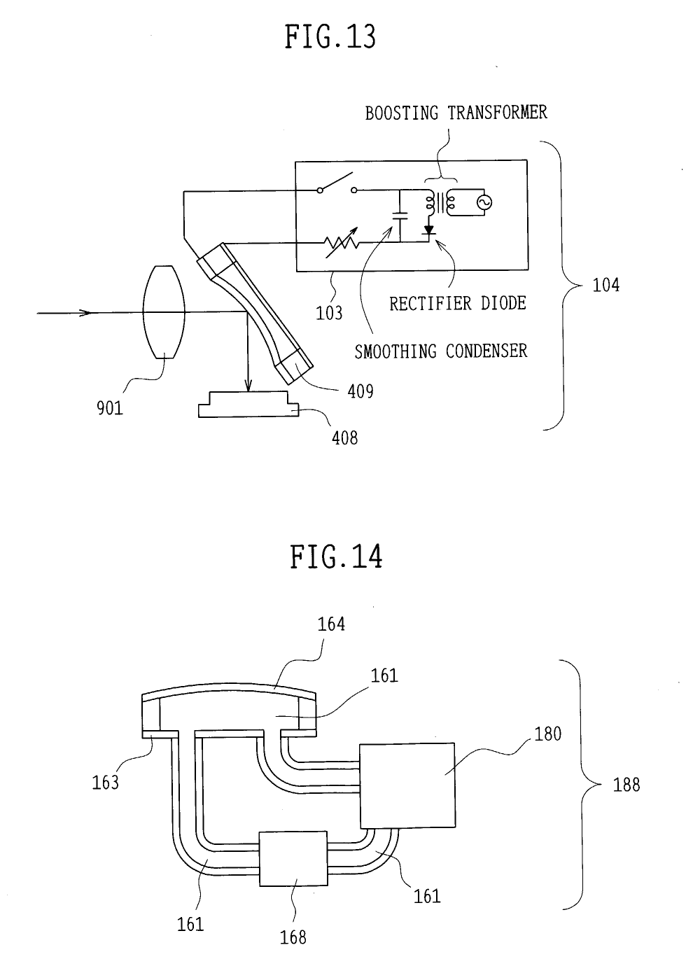

FIG. 13 is a schematic configuration diagram of an imaging system using the deformable mirror 409 according to the present invention, such as those applied to a digital camera for a cellular phone, a capsule endoscope, an electronic endoscope, a digital camera for a personal computer, and a digital camera for a PDA.

In this imaging system, the deformable mirror 409, the objective lens 901, the solid-state image sensor 408, and a control system 103 form an imaging unit 104. In the imaging unit 104, light passing through the objective lens 901 is reflected at the deformable mirror 409 and is imaged on the solid-state image sensor 408. The deformable mirror 409 is a kind of variable optical-property optical element, and is referred to also as a variable focus mirror.

According to this embodiment, even when the object distance is changed, the object can be brought into focus by deformation of the deformable mirror 409. Therefore, the configuration does not require any motor or the like to move the lenses and thus excels in achieving compact and lightweight design and low power consumption. Also, the imaging unit 104 is applicable, as an imaging system according to the present invention, to each of the embodiments. Also, if a plurality of deformable mirrors 409 are used, a zoom or variable-magnification imaging system or optical system can be constructed.

It is noted that, in FIG. 13, a configuration example of the control system 103 that includes a boosting circuit of a transformer using coils is shown. Specifically, use of a laminated piezoelectric transformer would facilitate compact design and thus is preferred. A boosting circuit may be used in any of deformable mirrors and variable focus lenses of the present invention that use electricity, and, in particular, is useful for a deformable mirror or a variable focus lens that utilizes electrostatic force or piezoelectric effect.

In practically assembling the imaging system of FIG. 13, it is necessary to go through the initial focus adjustment process, which is preferably performed by forming, on the solid-state image sensor 408, an image of a reference object disposed at a particular object distance, moving the solid-state image sensor 408 back and forth in the direction of the optical axis, and fixing the solid-state image sensor 408 at a position where the best focus condition is achieved. In this process, the reflecting surface of the deformable mirror 409 is set to assume a normal shape, for example, the shape of a plane surface.

This assemblage method is adopted because it has a merit that the deformation capability of the reflecting surface of the deformable mirror 409 can be fully used for focusing and zooming. If the solid-state image sensor 408 is fixed without the above-described position adjustment, a positioning error of the solid-state image sensor 408 would have to be compensated for by deformation of the deformable mirror 409, and accordingly the focusing range or the zooming range is narrowed.

If a sufficiently wide deformation range of the reflecting surface of the deformable mirror 409 is provided, the positioning of the solid-state image sensor 408 is not needed, as a matter of course. In this case, the initial focus adjustment may be made by deformation of the reflecting surface of the deformable mirror 409 so that the image of the reference object is formed in the best focus.

Also, the imaging system of FIG. 13 may be configured to use a photosensing substance such as a photographing film in place of the solid-state image sensor 408.

Also, a textured, a bright spot, a reticule illuminated by the light source or the like may be conveniently used as the reference object.

The exit end of the fiber connected with the light source, a pinhole placed in front of the light source, a backlighted textured or the like may be conveniently used as the bright spot.

FIG. 14 is a schematic configuration diagram of a deformable mirror 188, as the deformable mirror of the present invention, in which fluid 161 is taken in and out by a micropump 180 to deform a lens surface thereof. This embodiment has a merit that the lens surface can be considerably deformed.

The micropump 180 is, for example, a small-sized pump fabricated by micromachining technique and is configured to work using an electric power. The fluid 161 is sandwiched between a transparent substrate 163 and an elastic body 164.

As examples of the pump fabricated by the micromachining technique, there are those which use thermal deformation, piezoelectric substance, electrostatic force, etc.

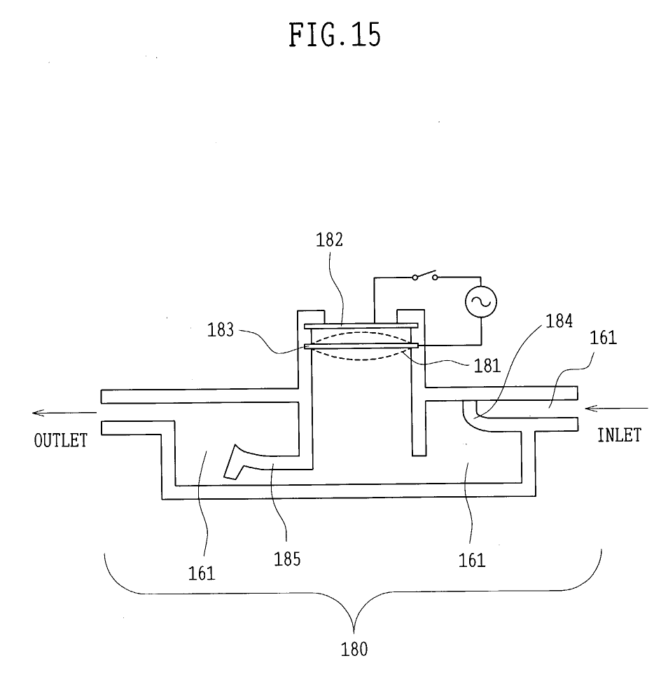

FIG. 15 is a schematic configuration diagram that shows one example of the micropump applicable to the deformable mirror according to the present invention. In the micropump 180, a vibrating plate 181 is vibrated by an electric force such as electrostatic force, piezoelectric effect or the like. FIG. 15 shows an example where vibration is caused by the electrostatic force. The reference numerals 182 and 183 denote electrodes. Also, the dash lines indicate the vibrating plate 181 as deformed. As the vibrating plate 181 vibrates, two valves 184 and 185 are opened and closed, to feed the fluid 161 from the right to the left.

The deformable mirror 188 of FIG. 14 functions as a deformable mirror upon the reflecting film 164 being deformed into a concave or convex surface in accordance with an amount of the fluid 161. In other words, the deformable mirror 188 is driven by the fluid 161. Organic or inorganic substance, such as silicon oil, air, water, and jelly, can be used as the fluid.

Also, a deformable mirror, a variable focus lens or the like using electrostatic force or piezoelectric effect sometimes requires a222222 high voltage for driving it. In this case, as shown in FIG. 13, for example, a boosting transformer or a piezoelectric transformer is preferably used to configure the control system.

Also, if the thin film 409a for reflection is provided also on a portion that is designed to cause no deformation, it can be conveniently used as a reference surface for measuring the shape of the deformable mirror with an interferometer or the like.

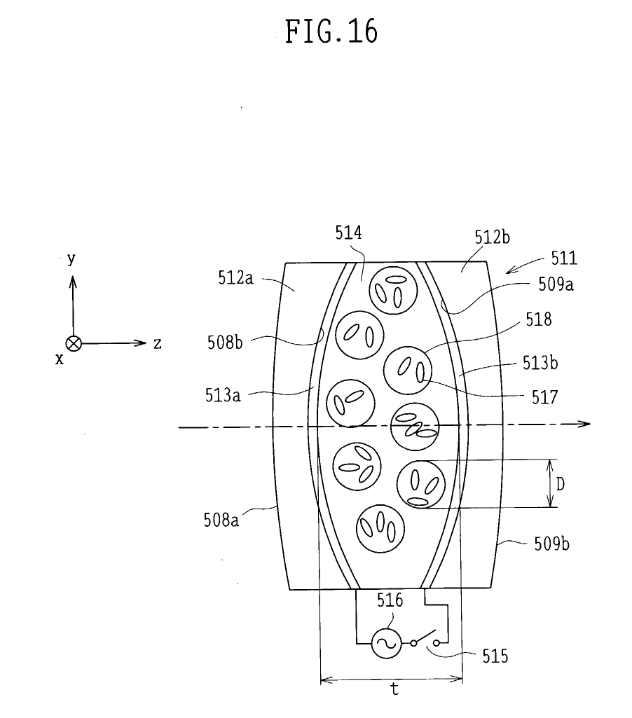

FIG. 16 shows the fundamental structure of a variable focus lens used in the later-described variable focus mirror, which can function as a deformable mirror. The variable focus lens 511 includes a first lens 512a having lens surfaces 508a and 508b as a first surface and a second surface, respectively, a second lens 512b having lens surfaces 509a and 509b as a third surface and a fourth surface, respectively, and a macromolecular dispersed liquid crystal layer 514 sandwiched between these lenses via transparent electrodes 513a and 513b. Incident light is converged through the first and second lenses 512a and 512b. The transparent electrodes 513a and 513b are connected with an alternating-current power supply 516 via a switch 515 so as to selectively apply an alternating-current electric field to the macromolecular dispersed liquid crystal layer 514. The macromolecular dispersed liquid crystal layer 514 is composed of a large number of minute macromolecular cells 518 with an arbitrary shape such as a sphere or a polyhedron each containing liquid crystal molecules 517, and its volume is equal to the sum of volumes occupied by macromolecules and the liquid crystal molecules 517 that constitute the macromolecular cells 518.

Here, the size of the macromolecular cell 518 is, in the case where the cell has a spherical shape, for example, chosen to satisfy the following condition:

2 nm≦D≦λ/5 (1)

where D is an average diameter of the cells and λ is a wavelength of light in use. That is, since the size of a liquid crystal molecule 517 is greater than 2 nm, the lower limit of the average diameter is set to 2 nm. Also, while the upper limit value of D depends on a thickness t of the macromolecular dispersed liquid crystal layer 514 in the direction of the optical axis of the variable focus lens 511, it is preferred, as described in detail later, that D is not greater than λ/5 because a large value of D in reference to λ would cause light to be scattered at the interface of the macromolecular cells 518 due to a difference in refractive index between the macromolecules and the liquid crystal molecules 517, to render the macromolecular dispersed liquid crystal layer 514 opaque. A high accuracy is not necessarily required, depending on an optical product using the variable focus lens. In this case, a diameter D not greater than the value of the wavelength λ is satisfactory. It is noted that the transparency of the macromolecular dispersed liquid crystal layer 514 deteriorates with increasing thickness t.

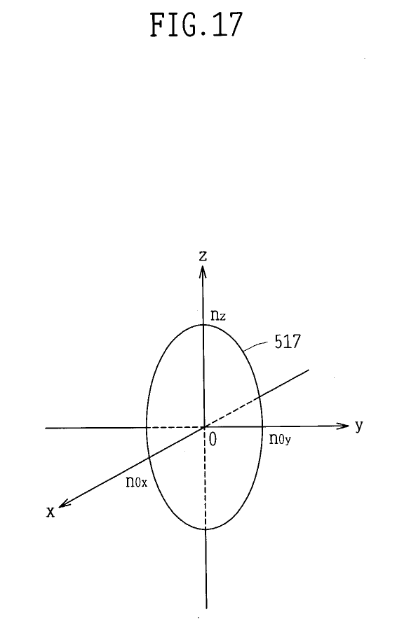

Also, as liquid crystal molecules 517, uniaxial nematic liquid crystal molecules are used. The refractive index ellipsoid of the liquid crystal molecules 517 is shaped as shown in FIG. 17 and satisfies the following condition:

nₒₓ=n_{oy}=nₒ (2)

where no is the refractive index for an ordinary ray and nₒₓ and n_{oy} are refractive indices in directions perpendicular to each other in a plane in which the ordinary ray lies.

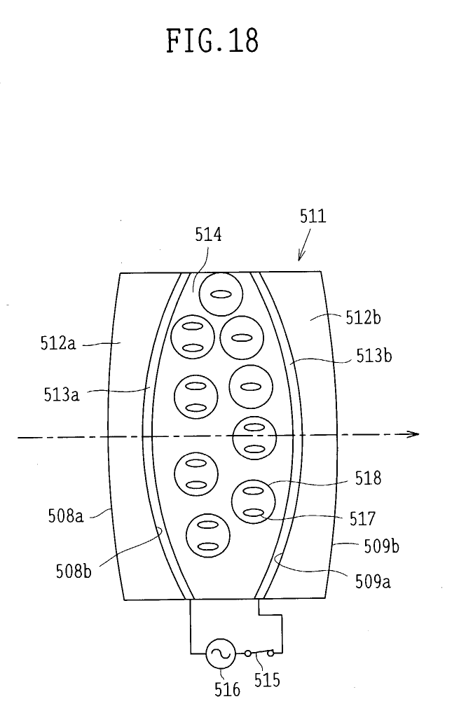

Here, in the condition where the switch 515 is turned off, as shown in FIG. 16, that is, where no electric field is applied to the macromolecular dispersed liquid crystal layer 514, the liquid crystal molecules 517 are oriented in various directions, and thus the refractive index of the liquid crystal layer 514 for incident light becomes high, to provide a lens having a strong refracting power. In contrast, in the condition where the switch 515 is turned on, as shown in FIG. 18, that is, where an alternating-current electric field is applied to the macromolecular dispersed liquid crystal layer 514, the liquid crystal molecules 517 are oriented so that the direction of the major axis of the refractive index ellipsoid is parallel to the optical axis of the variable focus lens 511, and thus the refractive index becomes low, to provide a lens having a weak refracting power.

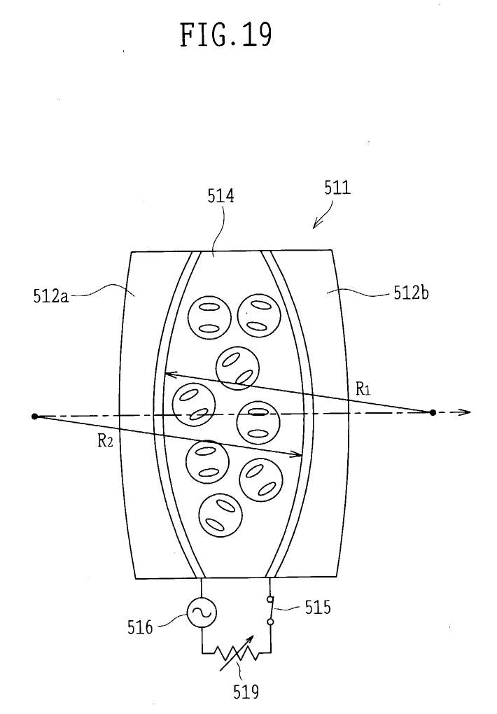

The voltage applied to the macromolecular dispersed liquid crystal layer 514 may be varied stepwise or continuously by a variable resistor 519, as shown in FIG. 19, for example. Such a configuration allows the refracting power to be varied stepwise or continuously because the liquid crystal molecules 517 are oriented so that the major axis of the ellipsoid is gradually turned to be parallel with the optical axis of the variable focus lens 511 according as the applied voltage increases.

Here, the average refractive index n_{LC}′ of the liquid crystal molecules 517 in the condition shown in FIG. 16, that is, the condition where no electric field is applied to the macromolecular dispersed liquid crystal layer 514, is approximately given by:

(nₒₓ+n_{oy}+n_{z})/3≡n_{LC}′ (3)

where the refractive index in the direction of the major axis of the refractive index ellipsoid is n_{z}.

Also, upon substituting the refractive index nₑ for the extraordinary ray into n_{Z}, the average refractive index n_{LC} in the condition where Equation (2) is established is given by:

(2nₒ+nₑ)/3≡n_{LC} (4)

In this case, the refractive index n_{A} of the macromolecular dispersed liquid crystal layer 514 is given by the Maxwell-Garnet's law as follows:

n_{A}=ff·n_{LC}′+(1−ff)n_{P} (5)

where the refractive index of the macromolecules constituting the macromolecular cells 518 is represented by n_{P}, and the volume ratio of the liquid crystal molecules 517 to the macromolecular dispersed liquid crystal layer 514 is represented by ff.

Consequently, the focal length f₁ of the variable focus lens 511 is given by:

1/f₁=(n_{A}−1) (1/R₁−1/R₂) (6)

where, as shown in FIG. 19, the radii of curvature of the inner surfaces of the lenses 512a and 512b, that is, the surfaces on the side of the macromolecular dispersed liquid crystal layer 514, are represented by R₁ and R₂, respectively. It is noted that a positive value is given to R₁ or R₂ when the center of curvature is located on the image point side. Also, refraction caused at the outer surfaces of the lenses 512a and 512b are removed from consideration. In other words, the focal length of the lens composed of the liquid crystal layer 514 alone is given by Equation (6).

Also, where the average refractive index for the ordinary ray is expressed by:

(nₒₓ+n_{oy})/2=nₒ′ (7)

the refractive index n_{B} of the macromolecular dispersed liquid crystal layer 514 in the condition shown in FIG. 18, that is, the condition where an electric field is applied to the macromolecular dispersed liquid crystal layer 514, is given by:

n_{B}=ff·nₒ′+(1−ff)n_{P} (8)

Consequently, in this condition, the focal length f₂ of the lens composed of the macromolecular dispersed liquid crystal layer 514 alone is given by:

1/f₂=(n_{B}−1) (1/R₁−1/R₂) (9)

Also, if a voltage lower than in the case of FIG. 18 is applied to the macromolecular dispersed liquid crystal layer 514, the focal length takes a value between the focal length f₁ given by Equation (6) and the focal length f₂ given by Equation (9).

From Equations (6) and (7), a change rate of the focal length caused by the macromolecular dispersed liquid crystal layer 514 is given by:

|(f₂−f₁)/f₂|=|(n_{B}−n_{A})/(n_{B}−1)| (10)

Thus, in order to increase the change rate, it is only necessary to increase the value of |n_{B}−n_{A}|. Here, since

n_{B}−n_{A}=ff(nₒ′−n_{LC}′) (11)

increasing |n_{O}′−n_{LC}′| increases the change rate. In practice, since n_{B} is about 1.3-2, the following range can be set:

0.01≦|nₒ′−n_{LC}′|≦10 (12)

Under this condition, when ff=0.5, the focal length produced by the macromolecular dispersed liquid crystal layer 514 is changeable by 0.5% or greater, and accordingly an effective variable focus lens can be obtained. It is noted that, since choice of liquid crystal substances is restricted, the value of |nₒ′−n_{LC}′| cannot exceed 10.

The ground of the upper limit value of Expression (1) is explained below. Wilson and Eck, “Solar Energy Materials and Solar Cells”, Vol. 31, 1993, published by Eleevier Science Publishers B. V. shows, in pp. 197-214 under the section title “Transmission variation using scattering/transparent switching films”, the variation of transmittance τ in accordance with the size variation of a macromolecular liquid crystal. Also, FIG. 6 on page 206 of the same document shows that, under the condition where t=300 μm, ff=0.5, nₚ=1.45, n_{LC}=1.585 and λ=500 nm, the theoretical value of transmittance τ is approximately 90% if r=5 nm (D =λ/50, D·t=λ·6 μm where the unit of D and λ is nanometers), and is approximately 50% if r=25 nm (D=λ/10), where the radius of the macromolecular dispersed liquid crystal is denoted by r.

Here, in a case where t=150 μm, for example, assuming that the transmittance τ varies as an exponential function of the thickness t, we can obtain that τ is approximately 71% when r=25 nm (D=λ/10, D·t=λ15 μm). Similarly, in a case where t=75 μm, τ is approximately 80% when r=25 nm (D=λ/10, D·t=λ·7.5 μm)

These results introduces that, if

D·t≦λ·15 μm (13)

then τ becomes 70%-80% or more, to allow the liquid crystal to be practically used as a lens. Therefore, for example, in the case where t=75 μm, a sufficient transmittance can be obtained if D ≦λ/5.

Also, the transmittance of the macromolecular dispersed liquid crystal layer 514 is raised as the value of n_{P} approaches the value of n_{LC}′. On the other hand, if nₒ′ and n_{P} take values different from each other, the transmittance of the macromolecular liquid crystal layer 514 is degraded. Regarding the liquid crystal layer 514 having the conditions shown in FIG. 16 and FIG. 18, the transmittance is improved on an average when the following condition is satisfied:

n_{P}=(nₒ′+n_{LC}′)/2 (14)

Here, since the variable focus lens 511 is used as a lens, it is preferred that its transmittance is, while being kept high, substantially constant whether in the condition of FIG. 16 or in the condition of FIG. 18. In order to achieve this, while choice is restricted for a substance of macromolecules constituting the macromolecular cells 518 and a substance of the liquid crystal molecules 517, for practical use, it is only necessary to satisfy the following condition:

nₒ′≦n_{P}≦n_{LC}′ (15)

If Equation (14) is satisfied, the requirement by Condition (13) is moderated and it is only necessary to satisfy the following condition:

D·t≦λ·60 μm (16)

The ground is as follows. According to the Fresnel's law, the reflectance is proportional to the square of the difference between refractive indices, and thus the amount of reflection of light at the interface between the macromolecules constituting the macromolecular cells 518 and the liquid crystal molecules 517, and accordingly the reduction in transmittance of the macromolecular dispersed liquid crystal layer 514, is roughly proportional to the square of the difference in refractive index between the macromolecules and the liquid crystal molecules 517.

The above explanation is based on the condition where nₒ′ is approximately 1.45 and n_{LC}′ is approximately 1.585. In a more general formulation manner, a necessary condition is given as:

D·t≦λ·15 μm·(1.585−1.45)²/(nᵤ−n_{P})² (17)

where (nᵤ−n_{P})² is the greater of (n_{LC}′−n_{P})² and (nₒ′−n_{P})².

Also, for a large variation of the focal length of the variable focus lens 511, a large value of ff is preferred. However, if ff=1, the volume of the macromolecules becomes zero, to make it impossible to form macromolecular cells 518. Therefore, the range is set as follows:

0.1≦ff≦0.999 (18)

On the other hand, since τ improves as ff decreases, Condition (17) is preferably modified as follows:

4×10⁻⁶[μm]²≦D·t≦λ·45 μm·(1.585−1.45)²/(nᵤ−n_{P})² (19)

Also, since the lower limit value of t is equal to D as shown in FIG. 16 and D is 2 nm or greater as explained above, the lower limit value of D·t is (2×10⁻³ μm)², namely 4×10⁻⁶[μm]².

It is noted that an approximation which expresses optical property of a substance by refractive index is established under the condition where D is 5-10 nm or larger, as set forth in T. Mukai, “Iwanami Science Library 8, Asteroids are coming”, 1994, Iwanami Shoten, p.58. Also, if the value of D exceeds 500λ, scattering of light is caused in a geometrical pattern, so that scattering of light at the interface between the macromolecules constituting the macromolecular cells and the liquid crystal molecules 517 is increased in accordance with the Fresnel's equation of reflection. Therefore, for practical use, D is chosen to satisfy the following condition:

7 nm≦D≦500λ (20)

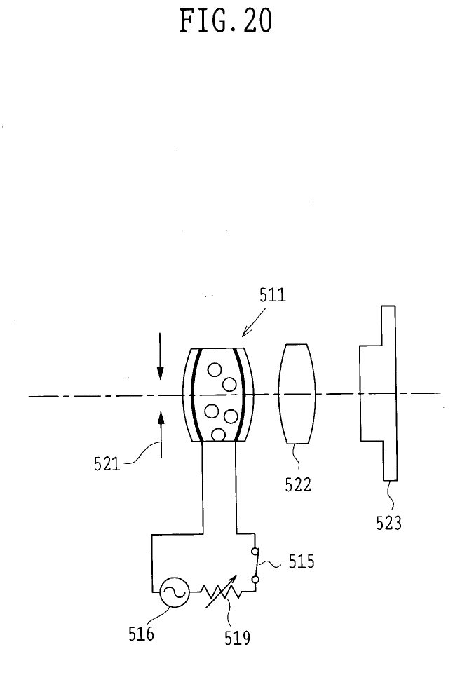

FIG. 20 shows the configuration of an imaging optical system for a camera, which optical system uses the variable focus lens 511 shown in FIG. 19. In this imaging optical system, an image of an object (not shown) is formed, via a stop 521, the variable focus lens 511 and a lens 522, on a solid-state image sensor 523 constructed of, for example, a CCD. In FIG. 20, illustration of liquid crystal molecules is omitted.

In this imaging optical system, the alternating voltage applied to the macromolecular dispersed liquid crystal layer 514 of the variable focus lens 511 is controlled by the variable resistor 519 to change the focal length of the variable focus lens 511. Whereby, continuous focusing on the object distance, for example, from infinity to 600 mm, can be achieved without moving the variable focus lens 511 or the lens 522 along the optical axis.

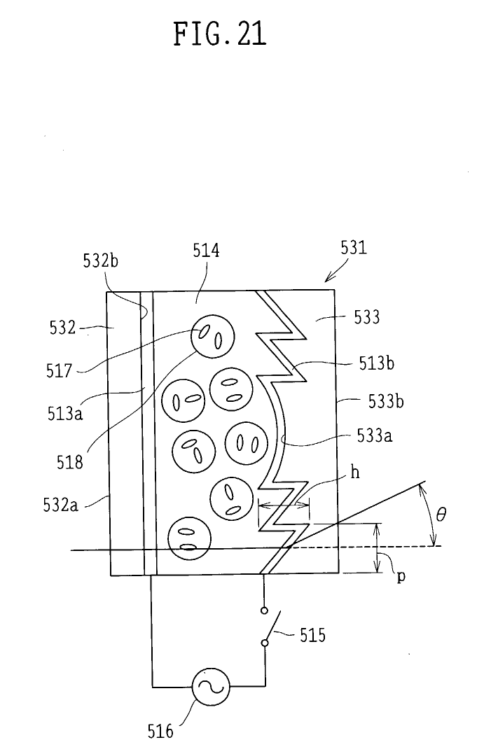

FIG. 21 is a diagram that shows one configuration example of a variable-focus, diffraction optical element using the principle of the variable focus lens.

This variable-focus, diffraction optical element 531 includes a first transparent substrate 532 having a first surface 532a and a second surface 532b parallel with each other and a second transparent substrate 533 having a third surface 533a that forms thereon an annular diffraction grating with a saw-like cross section having a groove depth of the order of the wavelengths of light and a fourth surface 533b that is flat. Incident light emerges through the first and second transparent substrates 532 and 533. As explained for FIG. 16, the macromolecular dispersed liquid crystal layer 514 is sandwiched between the transparent substrates 532 and 533 via the transparent electrodes 513a and 513b so that an alternating-current electric field is applied thereto as the transparent electrodes 513a and 513b are connected with the alternating-current power supply 516 via the switch 515.

In this configuration, a ray of light incident on the variable-focus, diffraction optical element 531 is emergent therefrom as deflected by an angle θ satisfying the following condition:

p sin θ=mλ (21)

where the grating pitch of the third surface 533a is represented by p and m is an integer. Also, if the following conditions are satisfied, the diffraction efficiency becomes 100% for a wavelength λ, to prevent production of flare:

h(n_{A}−n₃₃)=mλ (22)

h(n_{B}−n₃₃)=kλ (23)

where the groove depth is represented by h, the refractive index of the transparent substrate 33 is represented by n₃₃, and k is an integer.

Here, subtraction of Equation (23) from Equation (22) for both sides yields the following equation:

h(n_{A}−n_{B})=(m−k)λ (24)

Therefore, when it is assumed that λ=500 nm, n_{A}=1.55, and n_{B}=1.5, for example, then:

0.05 h=(m−k)·500 nm

and if it is further assumed here that m=1 and k=0,

h=10000 nm=10 μm

In this case, the refractive index n₃₃ of the transparent substrate 533 is given by Equation (22) as n₃₃=1.5. Also, if the grating pitch p on the periphery of the variable-focus, diffraction optical element 531 is 10 μm, θ is approximately 2.87° and accordingly a lens with F-number of 10 can be obtained.

Since this variable-focus, diffraction optical element 531 changes its optical path length in accordance with on-off operation of the voltage applied to the macromolecular dispersed liquid crystal layer 514, it can be disposed at a position where a beam of rays is non-parallel in the lens system so as to perform focus adjustment or to change the focal length of the entire lens system.

In this mode, regarding Condition (22)-(24), satisfying the following, less limited conditions are sufficient for practical use:

0.7mλ≦h(n_{A}−n₃₃)≦1.4mλ (25)

0.7kλ≦h(n_{B}−n₃₃)≦1.4mλ (26)

0.7(m−k)λ≦h(n_{A}−n_{B})≦1.4(m−k)λ (27)

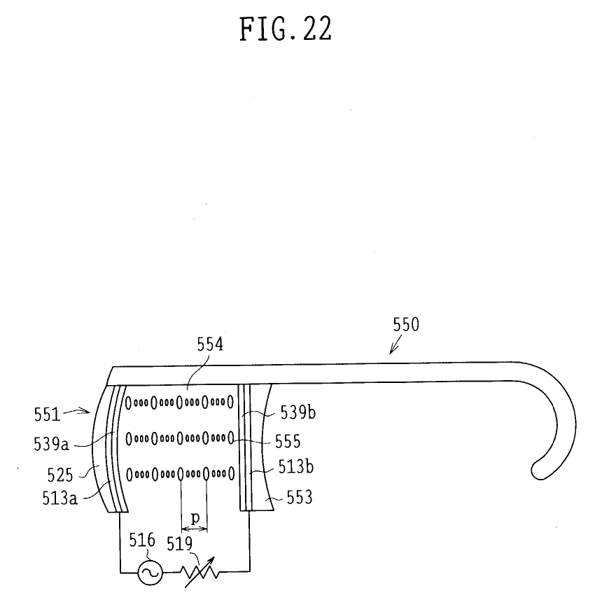

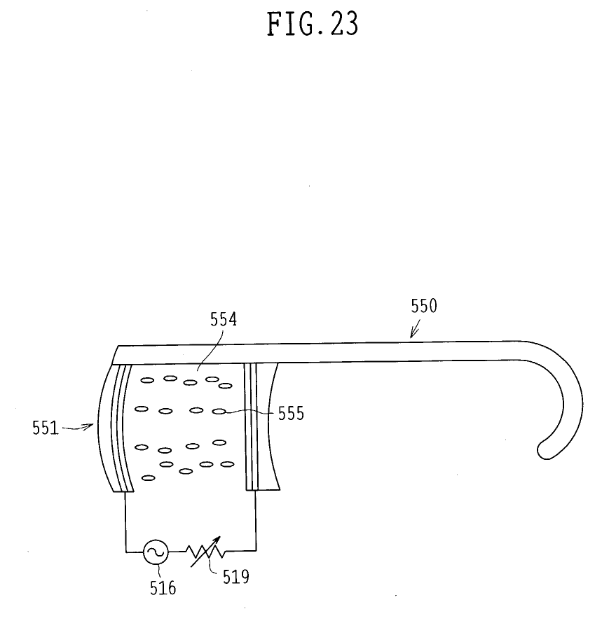

There is a variable focus lens that uses twisted nematic liquid crystal. FIG. 22 and FIG. 23 show a configuration of variable focus spectacles 550 of this type. A variable focus lens 551 includes lenses 552 and 553, orientation films 539a and 539b formed on the inner surfaces of these lenses via the transparent electrodes 513a and 513b, respectively, and a twisted nematic liquid crystal layer 554. The transparent electrodes 513a and 513b are connected with the alternating-current power supply 516 via the variable resistor 519 so as to apply an alternating-current electric field to the twisted nematic liquid crystal layer 554.

In this configuration, when the voltage applied to the twisted nematic liquid crystal layer 554 is increased, liquid crystal molecules 555 exhibit homeotropic orientation, as shown in FIG. 23, to produce a lower refractive index and a longer focal length of the twisted nematic liquid crystal layer 554 than in the twisted nematic condition shown in FIG. 22 where the applied voltage is lower.

Here, the spiral pitch P of the liquid crystal molecules 555 in the twisted nematic condition shown in FIG. 22 is required to be nearly equal to or much smaller than the wavelength λ of light, and thus we set the following condition, for example:

2 nm≦P≦2λ/3 (28)

The lower limit value of this condition depends on the size of liquid crystal molecules, while the upper limit value is set as a necessary condition for the twisted nematic liquid crystal layer 554 to act as an isotropic medium in the condition of FIG. 22 when incident light is natural light. If the upper limit value is exceeded, the variable focus lens 551 becomes a lens that has focal lengths differing by direction of polarization. Accordingly, a dual image is formed, or only a blurred image is obtained.

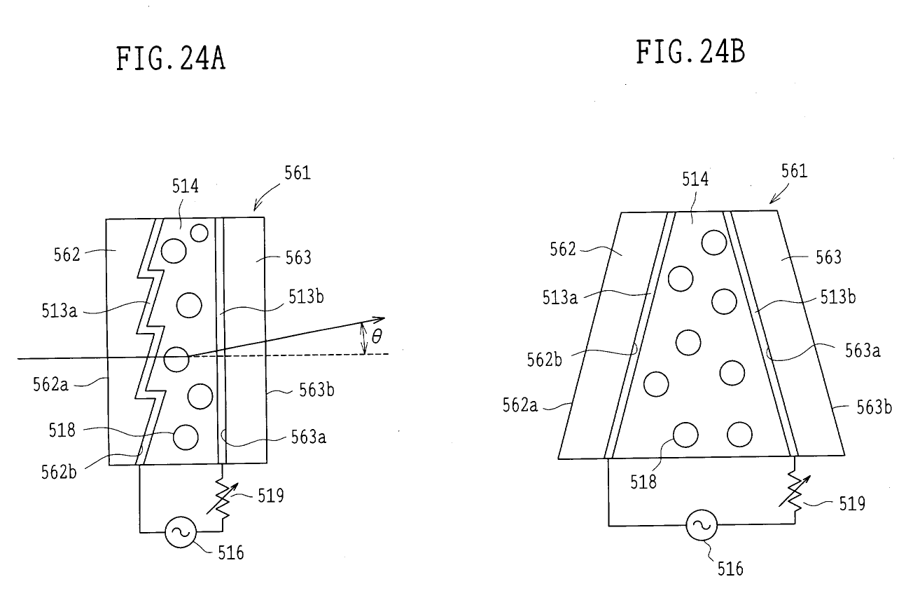

FIG. 24A shows a configuration of a variable deflection-angle prismusing the principle of the variable focus lens. The variable deflection-angle prism 561 includes an entrance-side, first transparent substrate 562 having a first surface 562a and a second surface 562b, and an exit-side, second transparent substrate 563 formed of a plane-parallel plate, having a third surface 563a and a fourth surface 563b. The inner surface (the second surface) 562b of the entrance-side, transparent substrate 562 is formed to have a Fresnel pattern. As explained for FIG. 16, the macromolecular dispersed liquid crystal layer 514 is sandwiched between this transparent substrate 562 and the exit-side, transparent substrate 563 via the transparent electrodes 513a and 513b. The transparent electrodes 513a and 513b are connected with the alternating-current power supply 516 via the variable resistor 519 so as to apply an alternating-current electric field to the macromolecular dispersed liquid crystal layer 514 for the purpose of controlling angle of deflection of light transmitted through the variable deflection-angle prism 561. In FIG. 24A, the inner surface 562b of the transparent substrate 562 is formed to have a Fresnel pattern. However, the prism may be configured as an ordinary prism with the inner surfaces of the transparent substrates 562 and 563 being inclined in reference to each other as shown in FIG. 24B or may be configured to have a diffraction grating shown in FIG. 21. In the latter case, Conditions (21)-(27) are applicable in the similar manner.

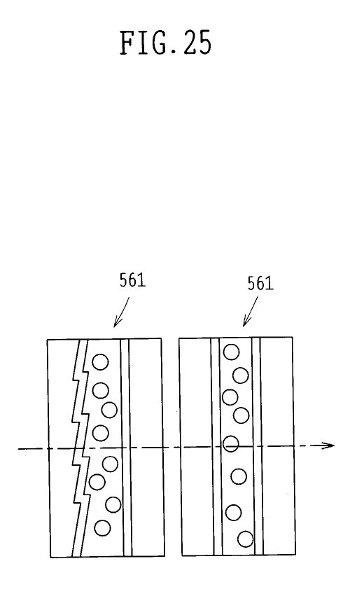

The variable deflection-angle prism 561 of this configuration can be effectively used for shake prevention for TV cameras, digital cameras, film cameras, binoculars etc. In this case, it is desirable that the direction of refraction (direction of deflection) by the variable deflection-angle prism 561 is vertical. In order to further improve performance, however, it is desirable. that two variable deflection-angle prisms 561 are arranged to have different directions of deflection such that, as shown in FIG. 25, angle of refraction is changeable in directions perpendicular to each other, or vertical and horizontal directions. In FIGS. 24 and 25, illustration of the liquid crystal molecules is omitted.

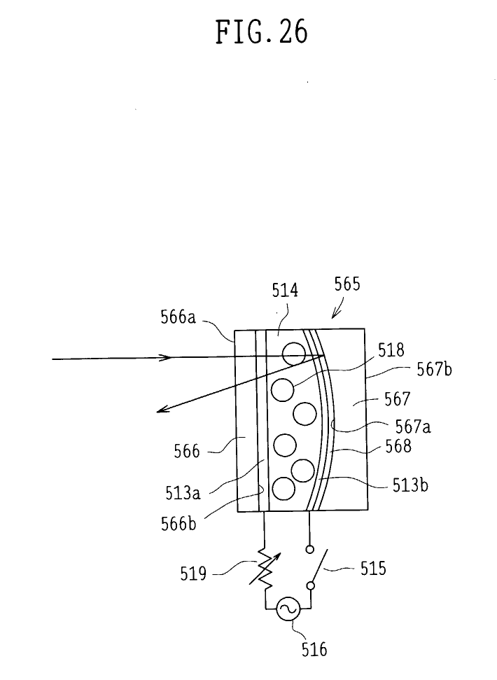

A variable focus mirror 565 shown in FIG. 26 also applies the principle of the variable focus lens. The variable focus mirror 565 includes a first transparent substrate 566 having a first surface 566a and a second surface 566b, and a second transparent substrate 567 having a third surface 567a and a fourth surface 567b. The first transparent substrate 566 is configured to have a flat plate shape or a lens shape and to be provided with the transparent electrode 513a on the inner surface (the second surface) 566b. The second transparent substrate 567 is configured so that the inner surface (the third surface) 567a thereof is shaped as a concave surface, which is coated with a reflecting film 568, on which the transparent electrode 513b is further provided. As explained for FIG. 16, the macromolecular dispersed liquid crystal layer 514 is sandwiched between the transparent electrodes 513a and 513b so that an alternating-current electric field is applied thereto as the transparent electrodes 513a and 513b are connected with the alternating-current power supply 516 via the switch 515 and the variable resistor 519. In FIG. 26, illustration of liquid crystal molecules is omitted.

In this configuration, since a ray of light incident on the mirror from the side of the transparent substrate 566 forms a path reciprocated in the macromolecular dispersed liquid crystal layer 514 by the reflecting film 568, the macromolecular dispersed liquid crystal layer 514 exerts its function twice. Also, by changing the voltage applied to the macromolecular dispersed liquid crystal layer 514, it is possible to shift the focal position for reflected light. In this case, since a ray of light incident on the variable focus mirror 565 is transmitted through the macromolecular dispersed liquid crystal layer 514 twice, when twice the thickness of the macromolecular dispersed liquid crystal layer 514 is represented by t, the numerical conditions set forth above are applicable in the similar manner. Also, the inner surface of the transparent substrate 566 or 567 can be configured as a diffraction grating, as shown in FIG. 21, to reduce the thickness of the macromolecular dispersed liquid crystal layer 514. This solution is favorable in reducing scattered light.

In the description set forth above, the alternating-current power supply 516 is used as a power source to apply an alternating-current electric field to the liquid crystal for the purpose of preventing deterioration of the liquid crystal. However, a direct-current power supply may be used to apply a direct-current electric field to the liquid crystal. Change of orientation of the liquid crystal molecules may be achieved by, not limited to the technique of changing the voltage, a technique of changing frequency of an electric field applied to the liquid crystals, intensity and frequency of a magnetic field applied to the liquid crystals, or temperature or the like of the liquid crystals.

In the configuration examples described above, some kind of the macromolecular dispersed liquid crystal is nearly a solid rather than a liquid. In such a case, therefore, one of the lenses 512a and 512b shown in FIG. 16, one of the transparent substrates 532 and 533 shown in FIG. 21, one of the lenses 552 and 553 shown in FIG. 22, the transparent substrate 563 shown in FIG. 24A, one of the transparent substrates 562 and 563 shown in FIG. 24B, or one of the transparent substrates 566 and 567 shown in FIG. 26 is dispensable. Also, in the present application, a variable focus mirror that is non-deformable as shown in FIG. 26 is classified into the deformable mirror.

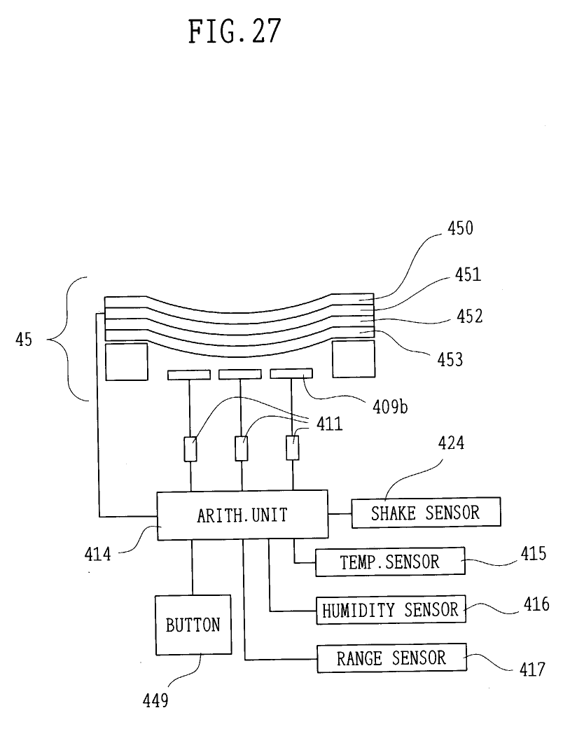

FIG. 27 shows still another embodiment of the deformable mirror according to the present invention. In this embodiment, explanation is made on the basis of the supposition that the deformable mirror is applied to a digital camera. In FIG. 27, the reference numeral 411 denotes a variable resistor, the reference numeral 414 denotes an arithmetical unit, the reference numeral 415 denotes a temperature sensor, the reference numeral 416 denotes a humidity sensor, the reference numeral 417 denotes a range sensor, and the reference numeral 424 denotes a shake sensor.

The deformable mirror 45 according to this embodiment is configured to provide a segmented electrode 409b disposed spaced away from an electrostrictive substance 453 made of an organic substance such as acrylic elastomer, to provide an electrode 452 and a deformable substrate 451 arranged in this order on the electrostrictive substance 453, and to provide a reflecting film 450 made of metal such as aluminum further on the substrate 451.

This configuration has a merit that the surface of the reflecting film 450 is made smoother than in the case where the segmented electrode 409b and the electrostrictive substance 453 are integrally constructed and thus aberrations are hard to generate optically. It is noted that the arrangement order of the deformable substrate 451 and the electrode 452 may be reversed.

In FIG. 27, the reference numeral 449 denotes a button for performing magnification change or zooming of the optical system. The deformable mirror 45 is controlled via the arithmetical unit 414 so that a user can change the shape of the reflecting film 450 for magnification change or zooming by pushing the button 449.

It is noted that a piezoelectric substance such as barium titanate set forth above may be used instead of the electrostrictive substance made of an organic substance such as acrylic elastomer.

Next, explanation is made of an embodiment regarding the deformable mirror of the present invention and an optical device using the same.

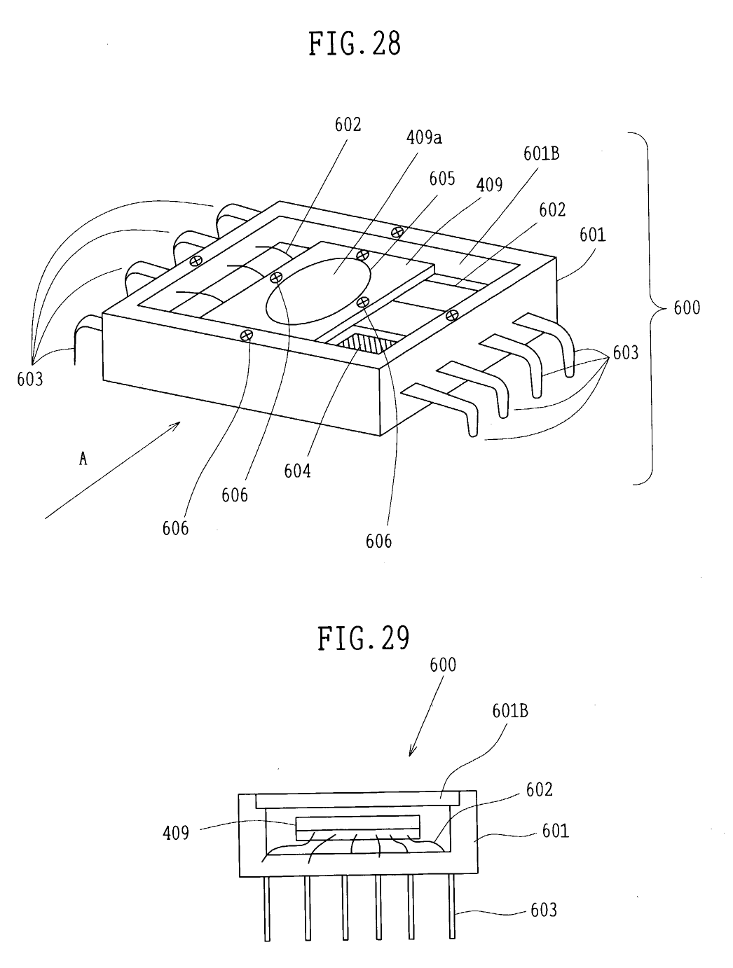

FIG. 28 is aperspective view of one embodiment of a deformable mirror device according to the present invention. The deformable mirror device 600 is configured so that a deformable mirror 409 of the type driven by electrostatic force, for example, is housed in a sealed insulator package 601 made of ceramic, plastic or the like for protecting the deformable mirror 409. The insulator package 601 is provided with a transparent window member 601B on the entrance and exit side of light so that light is incident on the reflecting surface 409a of the deformable mirror 409 through the transparent window member 601B and the light reflected at the reflecting surface 409a emerges through the transparent window member 601B. In FIG. 28, the reference numeral 602 denotes bonding wires, which connect lead wires 603 with the deformable mirror 409 so that electricity is supplied to the segmented electrode 409b, the reflecting surface 409a, which forms an electrode, etc. of the deformable mirror 409 that is described later in reference to FIG. 31.

The configuration may be made so that the insulator package 601 houses an IC 604, which includes electronic circuits required for driving the deformable mirror 409, together with the deformable mirror.

Also, it is preferred that the bonding wires 602 and the lead wires 603 extend in a direction across a direction that is parallel to the intersection of a plane on which a ray incident on and emergent from the deformable mirror 409 lies and the deformable mirror 409 (in FIG. 28, the longitudinal direction of the outline 605 of the beam transmitting region on the reflecting surface 409a as indicated by the arrow A). The reason is as follows. When the deformable mirror 409 is used as shown in FIG. 13, the direction corresponding to the direction of the arrow A in FIG. 28 is a direction along the figure. Here, if the lead wires 603 extend in the direction parallel to the direction corresponding to the direction of the arrow A, it is very likely that the lead wires obstruct the frame of the objective lens 901, the package of the solid-state image sensor 408 or the like.

If they do not obstruct the optical system, the lead wires 603 are permitted to extend in a direction substantially parallel to the longitudinal direction of the outline 605 of the beam transmitting region (the direction of the arrow A). Alternatively, as shown in FIG. 29, the lead wires may come out through the back surface of the insulator package 601. This configuration is favorable because the space on the back of the deformable mirror 409 shown in FIG. 13 is utilized.

In this embodiment, while the lead wires 603 are shown as one example of conductive electrodes, solder balls may be used instead of the lead wires, as a mater of course.

In FIG. 28, the reference numeral 606 denotes a positioning mark used in incorporating the deformable mirror device 600 into an optical apparatus. By arranging the positioning marks 606 on the insulator package 601, we can obtain an optical system using the deformable mirror 409 with smaller decentering. The positioning mark 606 may be shaped as a cross, a circle, an engraved groove, a hole, a dot or the like, and may be fabricated by printing, modifying the shape of the insulator package 601 or any other method as long as it can indicate a position. Also, the positioning mark 606 is preferably formed on the deformable mirror 409 as shown in FIG. 28, because such a configuration facilitates positioning of the deformable mirror 409 in reference to the insulator package 601.

Also, use of a substance that has infrared cutoff filter effect for the transparent window member 601B is advantageous because such an arrangement can save the space for arranging an infrared cutoff filter in the electronic imaging device using the solid-state image sensor 408 shown in FIG. 13.

Also, if an infrared cutoff coating constructed of a multilayered film is formed with transparent glass or the like on the transparent window member 601B using the technique of vacuum evaporation or the like, similar effect can be obtained.

In the present application, the above-mentioned electronic imaging device is classified into the optical device.

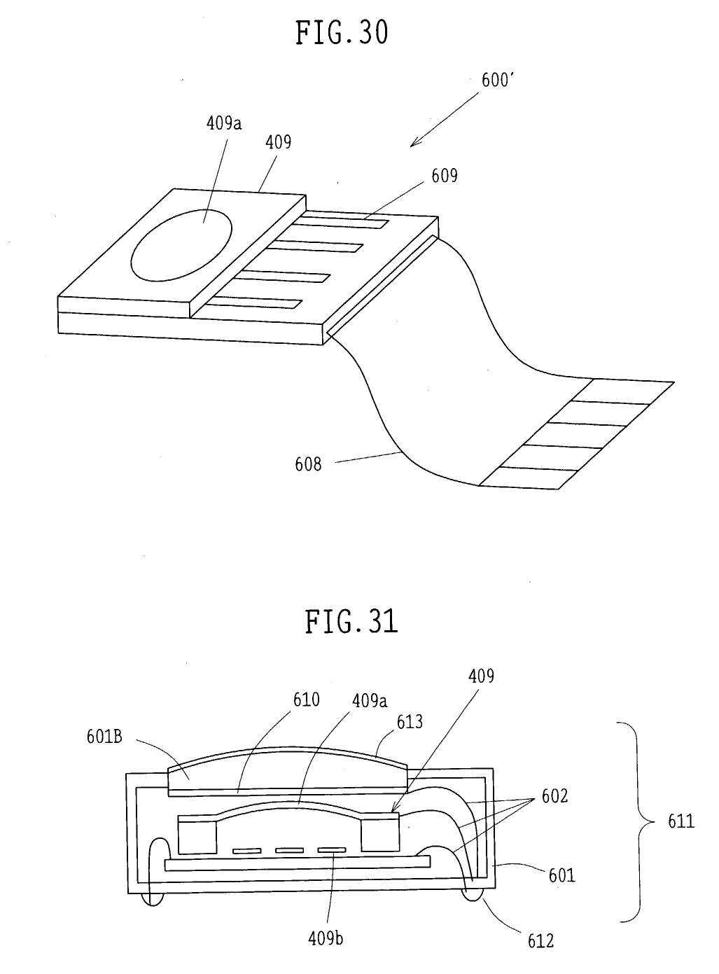

FIG. 30 is a perspective view of another embodiment of the deformable mirror device according to the present invention. In this embodiment, the deformable mirror device 600′ is configured so that a flexible substrate 608 is attached to the deformable mirror 409, to achieve connection of electrodes 609 extending from the segmented electrode 409b, which is described later in reference to FIG. 31, with a flexible printed wiring. The flexible substrate 608 also forms a conductive electrode.

In the embodiment of FIG. 30, while the configuration where the flexible substrate 608 is connected with the electrodes 609 is shown, the electrodes 609 may be directly connected with wiring not shown by soldering, without the intervening flexible substrate 608.

Regarding the deformable mirror of the present invention, it can be generally said that a region that does not receive a beam of rays in use on the reflecting surface 409a and the upper substrate region around the reflecting surface 409a are preferably painted black, to reduce reflection of undesired rays for precluding flare. Alternatively, these regions may be processed with a black coating instead of being painted black. In addition or alternatively, a black plate member having a hole may be fixed around the reflecting surface 409, to act as a flare stop.

In short, constructing the reflecting surface 409a, the deformable mirror 409, the insulator package 601 or the like to have a structure that reduces reflectance on the region not receiving a beam of rays in use is favorable for prevention of flare. Alternatively, executing surface treating is favorable for prevention of flare.

FIG. 31 is a schematic configuration diagram that shows still another embodiment of the deformable mirror device according to the present invention. The deformable mirror device 611 of this embodiment is configured so that the transparent window member 601B also is provided with a transparent electrode 610 and the reflecting surface 409a of the deformable mirror 409 of the type driven by electrostatic force is freely deformable to be concave or convex. The reference numeral 612 denotes a solder ball and the reference numeral 613 denotes an infrared cutoff coating film.

This configuration is favorable in that it can obtain twice the amount of deformation of the reflecting surface 409a for its simple structure. Not limited to the type driven by electrostatic force, a deformable mirror of the type driven by electromagnetic force may be used as the deformable mirror 409.

Also, the transparent window member 601B may have a lens shape, to form a part of the optical system. In this case, the optical system can be made compact. In the FIG. 31 example, the transparent window member 601B is formed to have a lens shape.

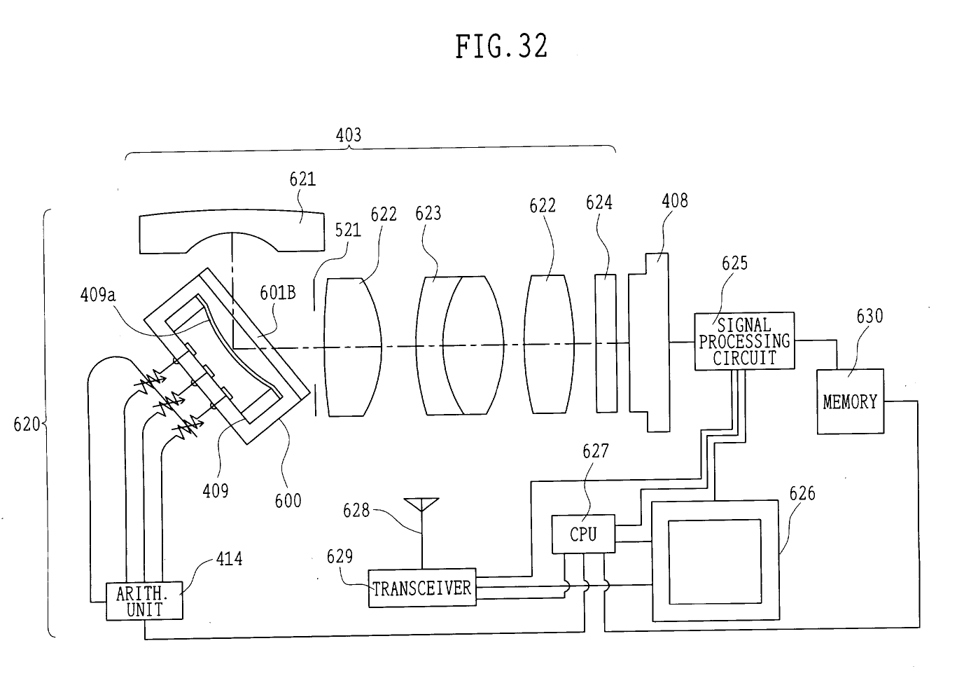

FIG. 32 is a schematic configuration diagram of a cellular phone 620 with electronic imaging function according to one embodiment of the optical device using the deformable mirror 600 shown in FIG. 28. In FIG. 32, the reference numeral 621 denotes a concave lens, the reference numeral 521 denotes a stop, the reference numeral 622 denotes a convex lens, the reference numeral 623 denotes a cemented lens, the reference numeral 624 denotes a low-pass filter, the reference numeral 625 denotes a signal processing circuit, the reference numeral 626 denotes a display unit, the reference numeral 627 denotes a central processing unit, the reference numeral 628 denotes an antenna, the reference numeral 629 denotes a transceiver, and the reference numeral 630 denotes a memory.

According to this embodiment, focusing can be performed by deformation of the reflecting surface 409a without shift of the lenses.

Alternatively, configuration may be made so that magnification change is performed by movement of all or a part of the convex lens 622 and the cemented lens 623 while shift of the in-focus position according to the magnification change being compensated for by the deformable mirror device 600. It is preferable that the both surfaces of the transparent window member 601B are provided with anti-reflection coating for prevention of ghost.

FIG. 33 is a schematic configuration diagram that shows an example where the transparent window member is arranged to be tilted in reference to the reflecting surface of the deformable mirror in the deformable mirror device shown in FIGS. 28-32.

As shown in FIG. 33, it is preferred to tilt the transparent window member 601B in reference to the reflecting surface 409a by the tilt angle θ, which is not smaller than 1° and not greater than 80°. That is, satisfying the following condition (29) is preferred:

1°≦θ≦80° (29)

If the tilt angle θ is smaller than 1°, ghost elimination cannot be achieved sufficiently, while, if greater than 80°, it makes it difficult to assemble the optical device. As can be said for every embodiment of the deformable mirror device according to the present invention, it is preferred that the insulator package 601 is provided with a ventilation hole 635 as shown in FIG. 33, to let the air in and out. Preparing the ventilation hole 635 is advantageous in that flow of the air allows the reflecting surface 409a to be easily deformed and accordingly speeds up deformation of the reflecting surface 409a.

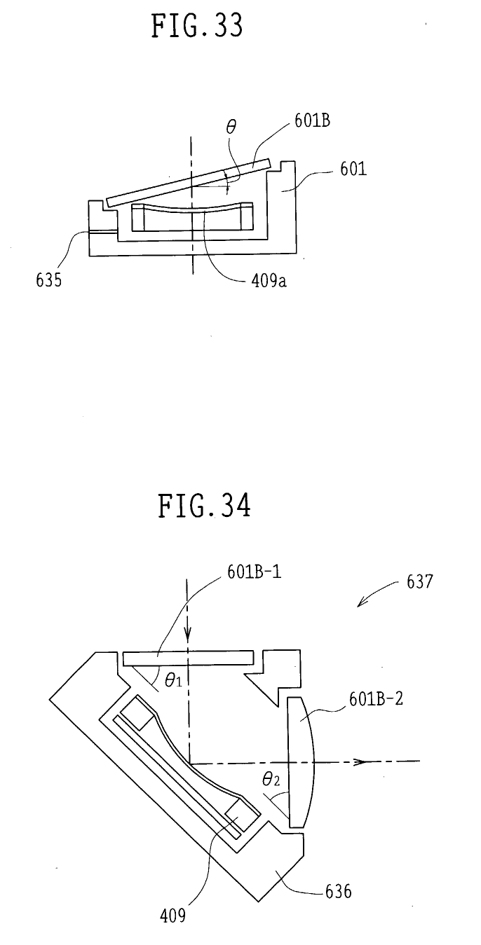

FIG. 34 is a schematic configuration diagram of still another embodiment the deformable mirror device according to the present invention. The deformable mirror device 637 is constructed as a insulator package 636 having a triangular prismatic shape, which is provided with two transparent window members 601B-1 and 601B-2.

The transparent window members 601B-1 and 601B-2 form windows on the entrance side and the exit side of light, respectively.

Here, it is preferred that the following conditions (30) and (31) are satisfied:

1°≦θ₁≦80° (30)

1°≦θ₂≦80° (31)

where θ₁ is a tilt angle of the transparent window member 601B-1 in reference to the reflecting surface 409a, and θ₂ is a tilt angle of the transparent window member 601B-2 in reference to the reflecting surface 609a. The ground is the same as described for Condition (29) in the FIG. 33 example.

Also, constructing at least one of the transparent window members 601B-1 and 601B-2 as a lens is preferred, because the remaining optical system is allowed to be simple. In FIG. 34, the transparent window member 601B-2 is a lens. Even in the case where at least one of the transparent window members 601B-1 and 601B-2 is formed as a lens, Conditions (30) and (31) are applicable.

Here, the tilt of θ degree in reference to the reflecting surface 409a is defined as follows.

If the reflecting surface 409a has a condition where it takes the shape of a plane surface, an angle measured in reference to this plane surface is taken as θ. If the reflecting surface 409a always is a curved surface, upon assuming a plane surface which is the approximation of the curved surface in the range of the beam of light passing therethrough, the angle in reference to this plane surface is taken as θ. Also, if the reflecting surface 409a changes inclination of the plane surface in accordance with deformation, it is only necessary that either one of Conditions (29), (30) and (31) is satisfied in either condition of the plane surface.

Also, as can be said for every deformable mirror device according to the present invention, the transparent window member 601B may be configured to act as a low-pass filter also. In the case where the deformable mirror device is used for an electronic imaging system, making the transparent window member 601B out of a birefringence substance such as crystal facilitates elimination of moiré and compact-sizing of the system and thus is favorable.

The deformable mirror device 637 may be produced as one block dispensing with at least one of the transparent window members 601B-1 and 601B-2. This is because the transparent window member 601B-1 or 602B-2 may be added in accordance with use.

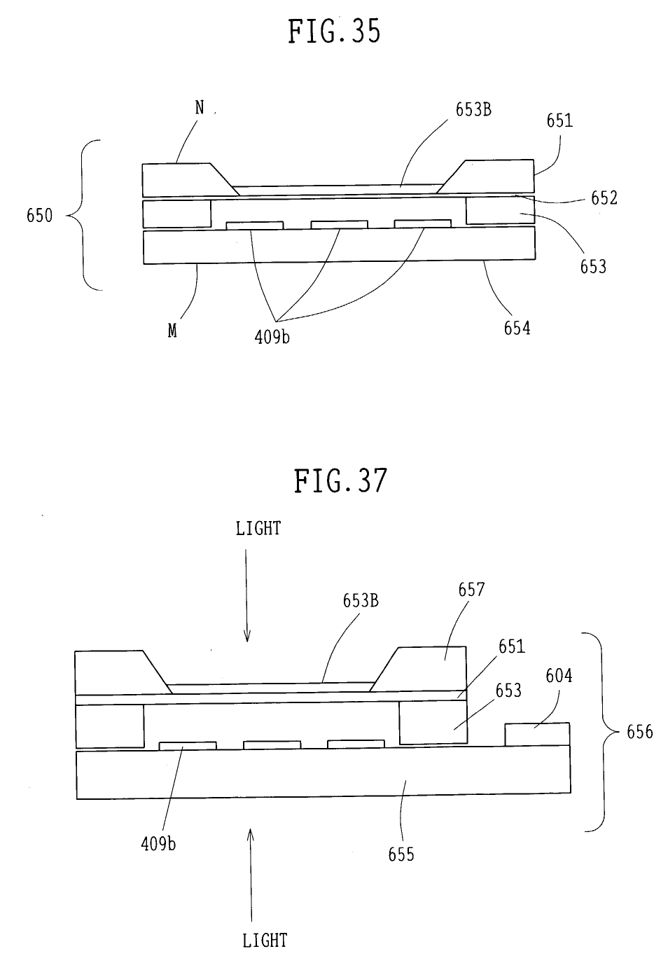

FIG. 35 is a sectional view of still another embodiment of the deformable mirror device according to the present invention.

This deformable mirror device 650 is fabricated by other method also than lithography. That is, an upper substrate 651 is made by cutting a piece off a metal plate. A thin polyimide film 652 is stuck on the upper substrate 651. A face where the polyimide film 652 is exposed is coated with an aluminum film 653B. A spacer 653 is made from a cut metal plate or the like and is sandwiched between the polyimide film 652 and a lower substrate 654. The segmented electrode 409b is formed on the lower substrate 654 by the printed-wiring technique.

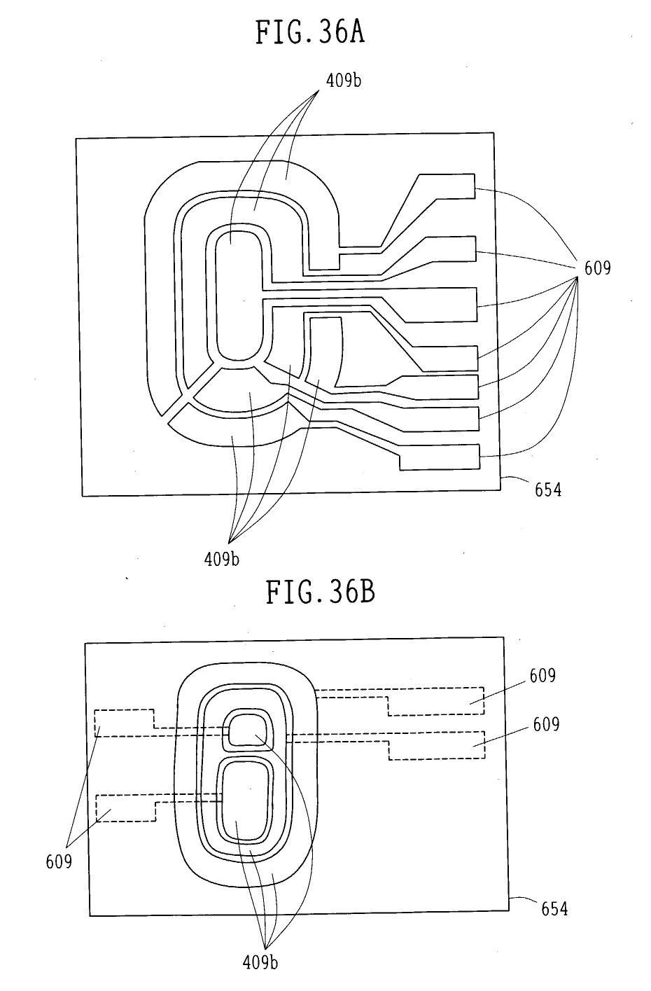

FIGS. 36 are explanatory diagrams that show examples of the lower substrate fabricated by the printed-wiring technique according to the embodiment of FIG. 35, where FIG. 36A shows the case of one-side wiring, while FIG. 36B shows the case of both-side wiring.

The lower substrate 654 is an insulator such as glass epoxy or glass plate. Etching (photographic etching) technique is used for formation of the segmented electrode 409b.

According to the variable mirror 650 of the embodiment shown in FIG. 35, since the upper substrate 651 and the lower substrate 654 can be fabricated without processing silicon using the lithography technique, manufacture cost can be reduced, which is favorable.

In the embodiment of FIG. 35, each of the upper substrate 651 and the lower substrate 654 is fabricated by a method other than lithography. However, only one of the substrates may be manufactured using the lithography technique, as a matter of course.

Also, as can be commonly said for the deformable mirror device according to the present invention, in fitting the deformable mirror in a mirror frame, it is preferred to perform positioning by aligning, in terms of the FIG. 35 embodiment, the top face N of the upper substrate 651 with the mirror frame, because it makes it easy to achieve what is parallel with the surface of the thin polyimide film 652. However, if the mechanical design does not allow the positioning in reference to the face N of the upper substrate 651, positioning may be performed by aligning the bottom face M of the lower substrate 654 with the mirror frame. Horizontal positioning can be made by aligning the outer circumference of the lower substrate 654 with a frame or the like.

FIG. 37 is a sectional view that shows still another embodiment of the deformable mirror device according to the present invention.

The deformable mirror device 656 of this embodiment exhibits one example of so-called “silicon-on-glass”, which employs a glass substrate. A lower substrate is configured to form a segmented electrode 409b and an IC 604 on a glass substrate 655 using lithography technique. An upper substrate 607 may be fabricated by using or not using lithography technique.

According to this embodiment, if the segmented electrode 409b is made as a transparent electrode, light can enter the device from both sides of the aluminum film 653B since the glass substrate 655 is transparent. Accordingly, application of the device to optical systems is widely ranged. Also, the glass substrate 655 may be replaced by other substance as long as it is a transparent substance such as synthetic resin.

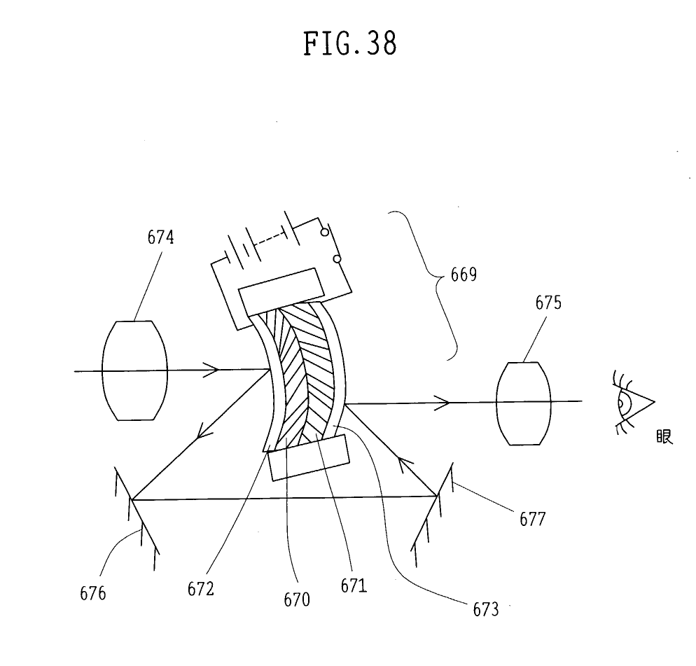

FIG. 38 is a sectional view that shows still another embodiment of an optical system using the deformable mirror device according to the present invention. In this optical system, the deformable mirror 669 is configured to provide electrodes 672 and 673 on both ends of piezoelectric substances 670 and 671 as applied to the deformable mirror 409 shown in FIG. 2. The electrodes 672 and 673 act as reflecting surfaces also, respectively, and constitute a Keplerian telescope in combination with lenses 674 and 675 and mirrors 676 and 677. Focusing or magnification change can be performed by deformation of the electrodes 672 and 673. The optical system shown in FIG. 38 may be configured to use the deformable mirror device 656 shown in FIG. 37 in place of the deformable mirror device 669.

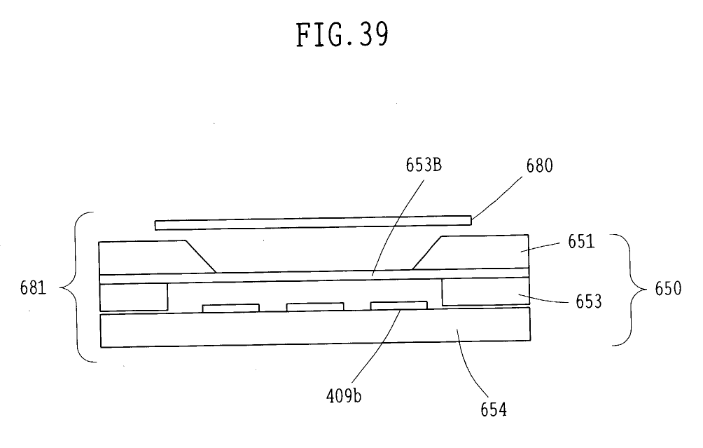

FIG. 39 is a schematic configuration diagram that shows still another embodiment of the deformable mirror device according to the present invention. The deformable mirror device 681 is configured to have the deformable mirror device 650 shown in FIG. 35, to which a vinyl thin film 680 provided with weak paste is applied for protecting the aluminum film 653B constituting the reflecting surface of the deformable mirror device 650. Regarding a substance for protecting the aluminum film 653B, it is noted that other synthetic resin, thin metal or the like may be used in place of vinyl. Also, a thin plate may be used in place of the thin film. In this embodiment, if the deformable mirror device is set in place in the optical device as the vinyl thin film 680 being applied thereto and then the vinyl thin film 680 is removed immediately before completion of assembling, risk of damage on the aluminum film 653B during assembling of the optical device is reduced.

Alternatively, in the case where the vinyl thin film 680 is removed immediately before commencement of optical device assembling so that the deformable mirror 650 is set in place, the aluminum film 653B can be protected from damage during transportation or the like of the deformable mirror device 681 in the form of a loose part before the optical device assembling.

Now, an optical system for processing optical data is described.

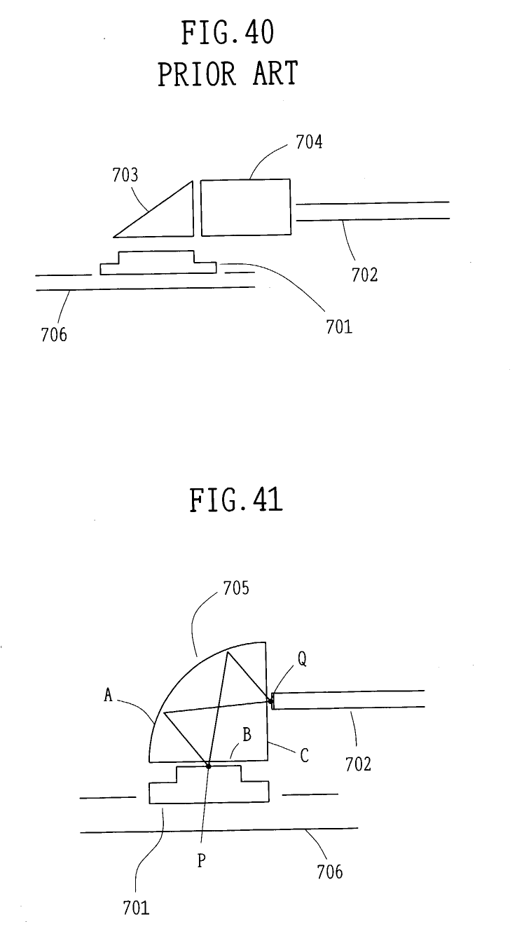

As shown in FIG. 40, in order to achieve optical connection of a surface illuminant laser 701 with an optical fiber 702, a triangular prism 703 and a SELFOC 704 have been conventionally used. However, this configuration has a defect that it requires a large number of parts. Therefore, as shown in FIG. 41, a configuration is made so that a single free curved surface prism 705 connects the surface illuminant laser 701 and the optical fiber 702. This configuration reduces the number of parts and, as a matter of course, cost and thus is advantageous.

In this case, it is preferred that a free curved surface A of the free curved surface prism 705 is shaped substantially as an ellipsoid of revolution. It is because, if laser light is designed to emanate from one point P on the surface illuminant laser 701 and to be imaged on a core Q of the optical fiber 702, the free curved surface A, which acts as a reflecting surface of the free curved surface prism 705, is required to be shaped as an ellipsoid of revolution having focuses at the points P and Q so that the laser light emanating from the point P is imaged on the core Q with no aberrations. In practice, there are a gap between a surface B, which acts as an entrance surface of the free curved surface prism 705, and the exit surface of the surface illuminant laser 701 and a gap between a surface C, which acts as an exit surface of the free curved surface prism 705, and the end face of the optical fiber 702, and, in addition, laser light at the point P on the surface illuminant laser 701, which is a light source, occupies a certain area. Therefore, in some cases, designing the shape of the free curved surface A to more or less deviate from the ellipsoid of revolution described above is rather suitable for image formation on the core Q.

A free curved surface A that has a shape deviating by not greater than 2 mm from the ellipsoid of revolution can achieve sufficient performance for practical use.

That is, there is practically little problem if the following condition (32) is satisfied:

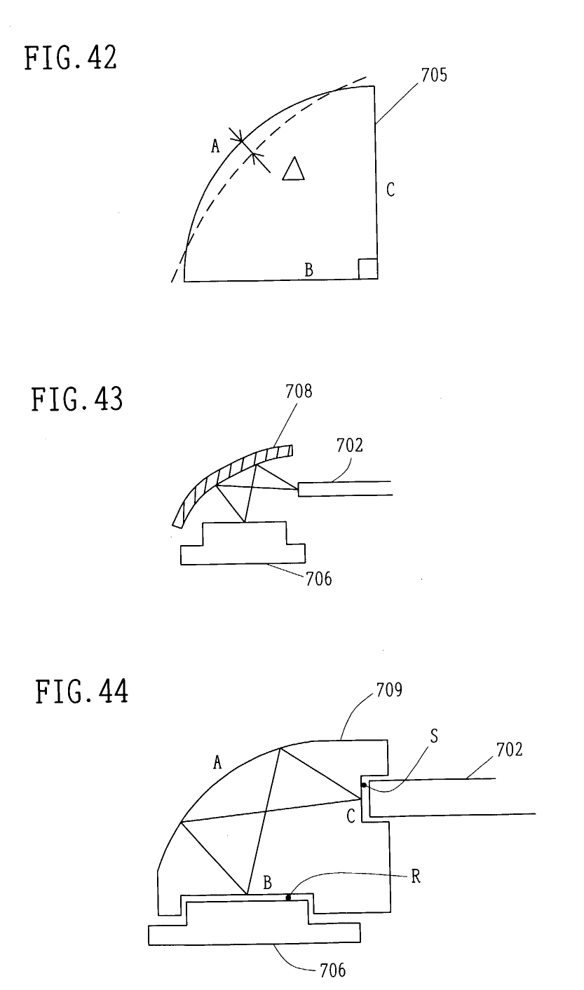

Δ≦2 mm (32)

where, as shown in FIG. 42, Δ is the amount of deviation of the free curved surface A from the ellipsoid of revolution (illustrated by dash line).

Moreover, if the following condition (33) is satisfied, a prism with much higher accuracy can be obtained.

Δ≦1 mm (33)

It is noted that the light source may be any kind, such as those using emergent light from a semiconductor laser waveguide, not limited to the surface illuminant laser.

Also, in the case where the surface illuminant laser 701, the triangular prism 703, the SELFOC 704, the free curved surface prism 705 or the like should be mounted on a substrate 706 as shown in FIGS. 40 and 41, the free curved surface prism 705 can be widely applied for deflecting light emergent perpendicular to the substrate 706 to travel in the horizontal direction, as shown in FIG. 41. It is noted that, in FIGS. 41 and 42, the free curved surface prism 705 is constructed so that the surface B and the surface C are substantially plane surfaces and are arranged substantially perpendicular to each other.

Also, a reflecting mirror 708 shown in FIG. 43 may be used in place of the free curve prism 705 shown in FIG. 41 for optically connecting the surface illuminant laser 706 with the optical fiber 702, as a matter of course.

FIG. 44 shows an embodiment in which a single free curved surface prism 705 connects the surface illuminant laser 607 with the optical fiber 702. In this embodiment, frames (recesses R and S in FIG. 44), which facilitate positioning of optical members such as the light source 706 and the optical fiber 702 at the entrance and exit positions of the free curved surface prism to achieve connection, are formed on the free curved surface prism 709. Also, the bottom face of the recess R is configured as the entrance surface B, and the bottom face of the recess S is configured as the exit surface C. The surfaces B and C are substantially plane surfaces and are formed to be perpendicular to each other. The free curved surface prism 709, which acts as frames also, can be easily brought into realization if manufactured by the technique of molding synthetic resin.

Also, in each of the optical systems shown in FIGS. 41-44, if the substrate 706 is replaced by a light receiving element, a waveguide or the like, the optical member 705, 708 or 709 can be used as an optical member that receives emergent light from the optical fiber 702 to let the light emerge.

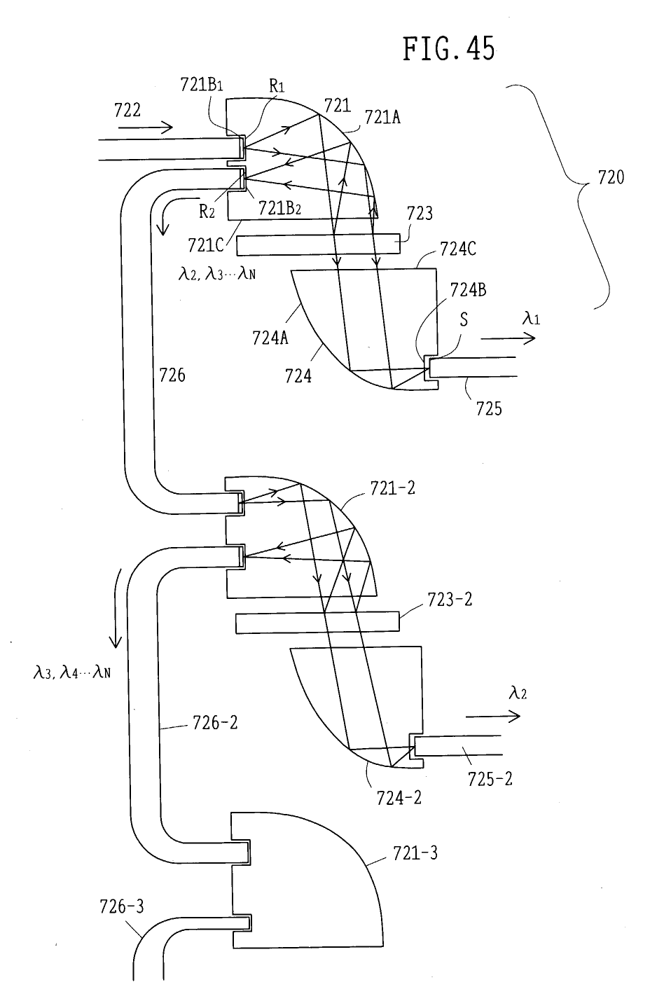

FIG. 45 is a schematic configuration diagram of an optical wavelength demultiplexer 720 used for optical wavelength division multiplexing (DWDM), which presents still another embodiment of the optical system for optical data processing using free curved surface prisms. The optical wavelength demultiplexer 720 includes optical fibers 722 and 726, a free curved surface prism 721, an interference filter 723, a free curved surface prism 724, and an optical fiber 725. The free curved surface prism 721 has a surface in which a recess R₁ functioning as a frame for facilitating positioning of the optical fiber 722 at the entrance position to achieve connection and a recess R₂ functioning as a frame for facilitating positioning of the optical fiber 726 at the exit position to achieve connection are formed, a free curved surface 721A, and a surface 721C. The bottom face of the recess R₁ forms an entrance face 721B₁, and the bottom face of the recess R₂ forms as an exit face 721B₂. The configuration is made so that the faces 721B₁ and 721B₂ and the surface 721C are substantially plane surfaces and that each of the faces 721B₁ and 721B₂ is perpendicular to the surface 721C.

The free curved surface prism 724 has a surface in which a recess S functioning as a frame for facilitating positioning of the optical fiber 725 at the entrance and exit position to achieve connection is formed, a free curved surface 724A, and a surface 724C. The bottom face of the recess S₁ forms an entrance and exit face 724B. The configuration is made so that the face 724B and the surface 724C are substantially plane surfaces and are perpendicular to each other.

In the optical wavelength demultiplexer 720 as configured above, if a mixed wave having wavelengths components of λ₁, λ₂, . . . , λ_{N} is emergent from the optical fiber 722 and incident on the entrance face 721B₁ of the free curved surface prism 721, the incident light is reflected at the free curved surface 721A to be a beam of substantially parallel rays, is emergent from the surface 721C, and is incident on the interference filter 723, to be divided into light with wavelength λ₁ and light with remaining wavelengths. Then, only the light with wavelength λ₁ is transmitted through the interference filter 723 and is incident on the entrance surface 724C of the free curved surface prism 724. The light incident on the entrance surface 724C of the free curved surface prism 724 is reflected at the free curved surface 724A of the free curved surface prism 724, is emergent from the face 724B as being collected, and enters the optical fiber 725.

On the other hand, the light with wavelengths λ₂, λ₃, . . . , λ_{N} reflected at the interference filter 723 is incident on the surface 721C of the free curved surface prism 721, is reflected again at the free curved surface 721A, is emergent from the exit face 721B₂ as being collected, and enters the optical fiber 726.

In this way, only the light with wavelength λ₁ is separated and is taken out from the optical fiber 725.

Then, light with wavelength λ₂ is separated by a similar structure reproduced by interposing an interference filter 723-2, which transmits light with wavelength λ₂ and reflects light with remaining wavelengths, between two free curved surface prisms 721-2 and 724-2, connecting the free curved surface prism 721-2 with the optical fiber 726 and an optical fiber 726-2, and connecting the free curved surface prism 724-2 with an optical fiber 725-2.

In the similar manner, light with wavelength λₙ (n: 3, 4, . . . N, where N is a positive number) can be separated by a structure reproduced by interposing a similar interference filter 723-n between two free curved surface prisms 721-n and 724-n, connecting the free curved surface prism 721-n with the optical fiber 726-(n-1) and an optical fiber 726-n, and connecting the free curved surface prism 724-n with an optical fiber 725-n.

In this case, those having the structure identical to the free curved surface prism 721 can be used as the free curved surface prisms 721-2, . . . 721-n. Also, those having the structure identical to the free curved surface prism 724 can be used as the free curved surface prisms 724-2, . . . , 724-n. Regarding the optical fibers 725-2, . . . , 725-n also, those having the structure identical to the optical fiber 725 can be used. Regarding the optical fibers 726-2, . . . , 726-n, those having the structure identical to the optical fiber 726 can be used.

In the optical wavelength demultiplexer shown in FIG. 45, the interference filters are constructed separate from the free curved surface prisms. However, they may be integrally constructed with free curved surface prisms by, for example, forming a interference film on the surface 721C of the free curve surface prism 721 or on the surface 724C of the free curved surface prism 724. If the device is configured as such, it can achieve, at lower cost, performance equivalent to that of a demultiplexer using a conventional heterogeneous lens.

Also, it is preferred that each of the free curved surfaces 721A and 724A of the free curved surface prisms 721 and 724 has the shape of a paraboroid of revolution having a focus in the vicinity of the entrance end of the optical fiber, of a paraboroid of resolution having a focus in the vicinity of the exit end of the optical fiber, or a shape approximating these paraboroids of revolution. This is because such a shape allows image forming with substantially no aberrations. In this embodiment also, if Conditions (32) and (33) are satisfied where Δ is a deviation of the free curved surface 721A or 724A from the paraboroid of revolution, the effect similar to the FIG. 41 embodiment can be achieved.

In the FIG. 45 embodiment, the recesses R₁, R₂ and S of the free curved surface prism 721 are to act as frames also for supporting the fibers.

Also, while each of the surfaces 721C and 724C of the free curved surface prisms 721 and 724 is preferably shaped as a plane surface, it may be shaped as a spherical surface, an aspherical surface or a free curved surface so as to reinforce the power of the free curved surfaces 721A and 724A or to compensate for aberrations generated at the free curve surfaces 721A and 724A. Also, free curved surface reflecting mirrors may be used instead of the free curved surface prisms 721 and 724. The surfaces 721A and 724A may be shaped as any other curved surfaces, not limited to the free curved surfaces.

In reference to FIG. 45, the description above has been made of the optical wavelength demultiplexer. However, if the traveling direction of light is reversed, the optical wavelength demultiplexer 720 can be used as an optical wavelength mixer. In this case also, if Conditions (32) and (33) are satisfied, the effect similar to the embodiment shown in FIG. 41 can be obtained.

At the end of the description, the terms used in the present invention are explained.

An optical device is a device including an optical system or an optical device. It is not necessary that the optical device can function by itself, that is, the optical device may be a part of an apparatus.

An imaging device, an observation device, a display device, an illumination device, an image processing device, etc. are classified into the optical device.

As examples of the imaging device, there are a film camera, a digital camera, robot eyes, a lens-exchange-type digital single-lens reflex camera, a TV camera, amotion-picture recording device, an electronic motion-picture recording device, a camcorder, a VTR camera, an electronic endoscope, etc. The digital camera, the card-type digital camera, the TV camera, the VTR camera, the motion-picture recording camera, etc. are examples of the electronic imaging device.

As examples of the observation device, there are a microscope, a telescope, spectacles, binoculars, a magnifying glass, a fiberscope, a finder, a viewfinder, etc.

As examples of the display device, there are a liquid crystal display, a viewfinder, a game machine (PlayStation by SONY), a video projector, a liquid crystal projector, a head mounted display (HMD), a personal data assistant (PDA), a cellular phone, etc.

As examples of the illumination device, there are a strobe for a camera, a headlight of an automobile, a light source for an endoscope, a light source for a microscope, etc.

As examples of the image-processing device, there are a cellular phone, a personal computer, a game machine, a read/write device for optical discs, an arithmetical unit in an optical computer, etc.

The image pickup element means, for example, a CCD, a pickup tube, a solid-state image sensor, a photographic film, etc. A plane parallel plate is classified into the prism. Change of the observer includes the case where diopter is changed. Change of the object includes the cases where the object distance is changed, where the object is displaced, where the object is moved, vibrated, or shaken, etc.

The expanded curved surface is defined as follows.

Not limited to a spherical, planar or rotationally symmetric aspherical surface, a surface may be configured as a spherical, planar or rotationally symmetric aspherical surface that is decentered from the optical axis, an aspherical surface defining planes of symmetry, only one plane of symmetry or no plane of symmetry, a free curved surface, a surface having an indifferentiable point or line, or the like. In addition, irrespective of whether it is a reflecting surface or a refracting surface, any surface is applicable as long as it can exert some effect on light. According to the present invention, these surfaces are generally referred to as expanded curved surfaces.

A variable focus lens, a variable mirror, a polarizing prism having a variable surface shape, a variable apex-angle prism, a variable diffraction optical element having a variable light-deflecting function, that is, a variable HOE or a variable DOE, etc. are classified into the variable optical-property optical element.

A variable lens that changes not the focal length but the amount of aberrations is classified into the variable optical-property optical element, also. Regarding the variable mirror also, similar classification is applied.

To conclude, an optical element that is changeable in light deflecting function such as reflection, refraction and diffraction is referred to as a variable optical-property optical element.

The data transmitting device is defined as a device that allows data to be input therein and transmits the data, such as a cellular phone, a fixed phone, a game machine, a remote controller of a TV set, a radio cassette recorder or a stereo set, a personal computer, and a keyboard, a mouse, a touch panel, etc. of a computer.

A TV monitor provided with an imaging device, and a monitor and a display of a personal computer also are classified into the data transmitting device.

Also, the data transmitting device is classified into the signal processing device.

Furthermore, in addition to the features recited in the claims, the features to be emphasized are shown below.

(1) A deformable mirror housed in a sealed package having a transparent window member.

(2) A deformable mirror provided with an electrode that is fabricated by printed-wiring technique.

(3) An optical device that performs focusing or magnification change using a deformable mirror that allows light to enter therein from both sides of the mirror surface.

(4) A deformable mirror housed together with a driving circuit in a sealed insulator package having a transparent window member.

(5) A deformable mirror according to Item (1), wherein a positioning mark is formed on the package.

(6) A deformable mirror housed in a sealed insulator package that has conductive electrodes coming outside the package and a transparent window member.

(7) A deformable mirror according to Item (6), wherein the conductive electrodes coming outside the package extend across a direction substantially parallel to the direction of the intersection of a plane in which a ray incident on and emergent from the deformable mirror lies with the reflecting surface of the deformable mirror.

(8) A deformable mirror according to Item (6), wherein the conductive electrodes are arranged on the back surface of the insulator package.

(9) A deformable mirror according to Item (6), wherein the conductive electrodes coming outside the package extend along a direction substantially parallel to the direction of the intersection of a plane in which a ray incident on and emergent from the deformable mirror lies with the reflecting surface of the deformable mirror.

(10) An optical device provided with a deformable mirror according to any one of Items (1) and (4)-(9), wherein the transparent window member has infrared cutoff effect.

(11) A deformable mirror according to any one of Items (1) and (4)-(9), wherein the window member is provided with a transparent electrode for deforming a reflecting surface of the deformable mirror.

(12) A deformable mirror according to any one of Items (1) and (4)-(9), wherein the transparent window member is configured as a lens.

(13) A deformable mirror according to any one of Items (1) and (4)-(9), wherein the transparent window member is tilted in reference to the reflecting surface of the deformable mirror.

(14) A deformable mirror according to Item (13), wherein the following condition is satisfied:

1°<θ<80°

where θ is a tilt angle of the transparent window member in reference to the reflecting surface of the deformable mirror.

(15) A deformable mirror according to any one of Items (1) and (4)-(9), wherein the package is provided with a ventilation hole.

(16) A deformable mirror according to any one of Items (1) and (4)-(9), wherein the deformable mirror has a plurality of transparent window members.

(17) A deformable mirror according to any one of Items (1) and (4)-(9), wherein the deformable mirror has a plurality of transparent window members, at least one of which is tilted in reference to the mirror surface of the deformable mirror.

(18) A deformable mirror according to any one of Items (1) and (4)-(9), wherein the deformable mirror has a plurality of transparent window members, at least one of which is configured as a lens.

(19) A deformable mirror according to Item (17) or (18), wherein at least one of the plurality of transparent window members satisfies the following condition:

1°<θ<80°

where θ is a tilt angle of the transparent window member in reference to the reflecting surface of the deformable mirror.

(20) A deformable mirror according to any one of Items (1) and (4)-(9), wherein the transparent window member is constructed of a low-pass filter.

(21) An imaging device provided with a deformable mirror according to Item (20).

(22) A deformable mirror using a flexible substrate as a conductive electrode.

(23) An imaging device having a deformable mirror according to any one of Items (1) and (4)-(22) for performing focusing or magnification change using the deformable mirror.

(24) A deformable mirror provided with an electrode fabricated by photographic etching technique.

(25) A deformable mirror having an electrode formed on a glass substrate.

(26) A deformable mirror characterized in that a transparent electrode is formed on a transparent substrate, so that light is allowed to be incident thereon from both sides of the mirror surface.

(27) A deformable mirror provided with an electrode formed on a glass substrate by photographic etching technique.

(28) A deformable mirror fabricated by both lithography and photographic etching techniques.

(29) A deformable mirror characterized in that light is allowed to be incident thereon from both sides of the mirror surface.

(30) A method for fitting a deformable mirror, wherein positioning is achieved by aligning an entrance-side substrate surface of the deformable mirror to a mirror frame.

(31) A method for fitting a deformable mirror, wherein positioning is achieved by aligning an entrance-side and reflecting-side substrate surface to a mirror frame.

(32) A deformable mirror having a thin film or a thin plate for protecting a reflecting surface of the deformable mirror.

(33) A method for assembling an optical device having a deformable mirror, wherein a thin film or a thin plate for protecting a reflecting surface of the deformable mirror is removed immediately before, during, or after assembling.

(34) A deformable mirror characterized in that a lower substrate having a fixed electrode is made of an insulator such as glass, and an upper substrate having a deformable mirror surface is fabricated using lithography process of silicon.

(35) A deformable mirror characterized in that a lower substrate having a fixed electrode is fabricated by forming a conductive electrode on an insulator such as glass using photographic etching technique, and an upper substrate having a deformable mirror surface is fabricated using lithography process of silicon.

(36) A deformable mirror according to Item (34) or (35), characterized in that the deformable mirror surface is fabricated by forming a metal thin film formed on a film of an organic substance.

(37) A method for assembling, an apparatus for assembling, or a resulted device of assembling an imaging device that has a deformable mirror and an image pickup element, characterized in that an initial focus adjustment is made, under a reference condition of the deformable mirror, by fixing the image pickup element at a position where an image of a reference object on the image pickup element is in a best focus condition.

(38) A method for assembling, an.apparatus for assembling, or a resulted device of assembling an imaging device that has a deformable mirror and an image pickup element, characterized in that an initial focus adjustment is made by defining a reference condition of the deformable mirror at a position where an image of a reference object on the image pickup element is in a best focus condition.

(39) A deformable mirror characterized in that, on a reflecting surface thereof, a region that does not receive a beam of rays in use undergoes surface treating that reduces reflectance, to preventing flare.

(40) A deformable mirror characterized in that a member arranged about a reflecting surface of the deformable mirror undergoes surface treating that reduces reflectance, to prevent flare.

(41) A deformable mirror according to Item (39) or (40), characterized in that the surface treating that reduces reflectance is application of black paint or black coating.

(42) A deformable mirror characterized in that a structure that reduces reflectance is provided for a member around a reflecting surface of the deformable mirror, to prevent flare.

(43) A deformable mirror according to Item (42), wherein the structure that reduces reflectance is a flare stop.

As described in detail above, the present invention can provide a variable mirror or an optical device provided with the variable mirror that consumes a small power, is silent, has a short response time, has a simple mechanical structure, hardly is scratched, and contributes to cost reduction.

What is claimed is:

1. An optical system that performs optical data processing, said optical system comprising a free curved surface prism or a free curved surface reflecting mirror for deflecting light emergent in a direction perpendicular to a substrate to travel in a horizontal direction.

2. An optical system that performs optical data processing, said optical system comprising a free curved surface prism or a free curved surface reflecting mirror for deflecting light incident in a horizontal direction to travel perpendicular to a substrate.

3. An optical system according to claim 1, wherein a free curved surface of said free curved surface prism or said free curved surface reflecting mirror is substantially shaped as an ellipsoid of revolution.

4. An optical system according to claim 1, wherein a free curved surface of said free curved surface prism or a free curved surface reflecting mirror has a shape deviating from an ellipsoid of revolution within +−2 mm.

5. An optical system according to claim 2, wherein a free curved surface of said free curved surface prism or a free curved surface reflecting mirror has a shape deviating from an ellipsoid of revolution within +−2 mm.

6. An optical system according to claim 1, wherein the light emergent in a direction perpendicular to said substrate is semiconductor laser light.

7. An optical system according to claim 1, wherein the light emergent in a direction perpendicular to said substrate is surface illuminant laser light.

8. An optical system according to claim 2, wherein said optical system further comprises an optical fiber, from which the light incident in a horizontal direction emerges.

9. A free curved surface prism or a free curved surface reflecting mirror used in an optical system that performs optical data processing, wherein surfaces of said free curved surface prism or of said free curved surface reflecting mirror are provided with portions that are shaped to act as frames for optical parts, such as a fiber, a light source, and a waveguide, which are designed to be connected with said free curved surface prism or said free curved surface reflecting mirror.

10. An optical system according to claim 1, wherein said free curved surface prism or said free curved surface reflecting mirror is made of synthetic resin.

11. A free curved surface prism or a free curved surface reflecting mirror according to claim 9, wherein said free curved surface prism or said free curved surface reflecting mirror is made of synthetic resin.

12. An optical system that performs optical data processing, said optical system using a free curved surface prism or a free curved surface reflecting mirror for optically connecting an optical part with another optical part.

13. A free curved surface prism or a free curved surface reflecting mirror included in an optical system that performs optical data processing, wherein said free curved surface prism or a free curved surface reflecting mirror has a means to optically connect an optical part with another optical part.

14. An optical system that performs optical data processing, said optical system comprising a free curved surface prism used to optically connect an optical part with another optical part, said free curved surface prism having two plane surfaces that form substantially an angle of 90 degrees.

15. A free curved surface prism usable in an optical system that performs optical data processing, wherein said free curved surface prism is used to optically connect an optical part with another optical part, and has two plane surfaces that form substantially an angle of 90 degrees.

16. An optical system that performs optical data processing, said optical system comprising a free curved surface prism or a free curved surface reflecting mirror that causes an incident direction and an emergent direction of light to substantially form an angle of 90 degrees.

17. A free curved surface prism or a free curved surface reflecting mirror usable in an optical system that performs optical data processing, wherein an incident direction and an emergent direction of light substantially form an angle of 90 degree.

18. A wavelength demultiplexer comprising:
two curved surface prisms or two curved surface reflecting mirrors; and
a filter that is disposed between said two curved surface prisms or said two curved surface reflecting mirrors and selectively reflects and transmits light with different wavelengths.

19. A wavelength demultiplexer according to claim 18, wherein each of curved surfaces of said two curved surface prisms or said two curved surface reflecting mirrors is shaped as a free curved surface or a paraboroid of revolution.

20. A wavelength demultiplexer according to claim 19, wherein at least one of the following conditions is satisfied:
Δ≦2 mm
Δ≦1 mm
where Δ is an amount of deviation of said curved surface from an ellipsoid of revolution.

21. A wavelength demultiplexer system comprising a plurality of wavelength demultiplexers that are connected together in a cascade arrangement, wherein each of said wavelength demultiplexers comprises two curved surface prisms or two curved surface reflecting mirrors, and a filter that is disposed between said two curved surface prisms or between said two curved surface reflecting mirrors and selectively reflects and transmits light with different wavelengths.

22. A wavelength demultiplexer according to claim 18, wherein said wavelength demultiplexer is prepared to be used for optical wavelength division multiplexing.

23. A wavelength mixer comprising:
two curved surface prisms or two curved surface reflecting mirrors; and
a filter that is disposed between said two curved surface prisms or between said two curved surface reflecting mirrors and selectively reflects and transmits light with different wavelengths.

24. A wavelength mixer according to claim 23, wherein each of curved surfaces of said two curved surface prisms or said two curved surface reflecting mirrors is shaped as a free curved surface or a paraboroid of revolution.

25. A wavelength mixer according to claim 24, wherein at least one of the following conditions is satisfied:
Δ≦2 mm
Δ≦1 mm
where Δ is an amount of deviation of said curved surface from an ellipsoid of revolution.

26. A wavelength mixer system comprising a plurality of wavelength mixers that are connected together in a cascade arrangement, wherein each of said wavelength mixers comprises two curved surface prisms or two curved surface reflecting mirrors, and a filter that is disposed between said two curved surface prisms or between said two curved surface reflecting mirrors and selectively reflects and transmits light with different wavelengths.

27. A wavelength mixer according to claim 23, wherein said wavelength mixer is prepared to be used for optical wavelength division multiplexing.
